(19) United States
(12) Patent Application Publication
(10) Pub. No.: US 2025/0200430 A1
(43) Pub. Date: Jun. 19, 2025

(54) APPARATUS AND METHODS FOR ASSISTED LEARNING

(71) Applicant: BREAKOUT LEARNING Inc., Dallas, TX (US)

(72) Inventors: Ramit Varma, Encino, CA (US); Steven Walters, Dallas, TX (US); Joshua Oster-Morris, Atlanta, GA (US)

(73) Assignee: BREAKOUT LEARNING Inc., Dallas, TX (US)

(21) Appl. No.: 18/543,914

(22) Filed: Dec. 18, 2023

(51) Int. Cl. G06N 20/00

(52) U.S. Cl. CPC G06N 20/00; G06Q 50/20

(57) ABSTRACT

An apparatus for assisted learning, wherein the apparatus includes at least a processor and a memory containing instructions configuring the at least a processor to receive user data pertaining to a user, wherein the user data includes user activity data, determine an interaction indicator by evaluating the user activity data using a behavioral analysis module, wherein determining the interaction indictor includes identifying a user archetype based on user activity data and validate the user archetype against a pre-defined set of behavioral archetypes, selectively initiate a user event based on the validated user archetype, and iteratively listen for a user response to the user event, wherein the user response alerts a subsequent interaction indicator upon a re-evaluation of the user activity data using the behavioral analysis module.

### FIELD OF THE INVENTION

The present invention generally relates to the field of machine learning. In particular, the present invention is directed to apparatus and methods for assisted learning.

### BACKGROUND

Currently, challenges in effective and tailored educational content delivery lies in the inability of conventional digital systems to dynamically adapt to individual student needs and provide timely feedback. Existing educational systems often lack the capability to recognize and respond to diverse (learning) events remotely in digital environment in real-time.

### SUMMARY OF THE DISCLOSURE

In an aspect, an apparatus for assisted learning is described. The apparatus includes at least a processor and a memory communicatively connected to the at least a processor, wherein the memory contains instructions configuring the at least a processor to receive user data pertaining to a user, wherein the user data includes user activity data, determine an interaction indicator by evaluating the user activity data using a behavioral analysis module, wherein determining the interaction indictor includes identifying a user archetype based on user activity data and validate the user archetype against a pre-defined set of behavioral archetypes. The processor is further configured to selectively initiate a user event based on the validated user archetype and iteratively listen for a user response to the user event, wherein the user response alerts a subsequent interaction indicator upon a re-evaluation of the user activity data using the behavioral analysis module.

In another aspect, a method for assisted learning is described. The method includes receiving, by at least a processor, user data pertaining to a user, wherein the user data includes user activity data, determining, by the at least a processor, an interaction indicator by evaluating the user activity data using a behavioral analysis module, wherein determining the interaction indictor includes identifying a user archetype based on user activity data and validate the user archetype against a pre-defined set of behavioral archetypes. The method further includes selectively initiating, by the at least a processor, a user event based on the validated user archetype and iteratively listening, by the at least a processor, for a user response to the user event, wherein the user response alerts a subsequent interaction indicator upon a re-evaluation of the user activity data using the behavioral analysis module.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for assisted learning;

FIG. 2 is a block diagram of an exemplary embodiment of a machine learning module;

FIG. 3 is a block diagram of an exemplary embodiment of a chatbot;

FIG. 4 is a diagram of an exemplary embodiment of a neural network;

FIG. 5 is a block diagram of an exemplary embodiment of a node of a neural network;

FIGS. 6A-B are depictions of exemplary interfaces;

FIG. 7 is a flow diagram illustrating an exemplary embodiment of a method for assisted learning; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure allow for optimizing the learning experience and enhancing educational content delivery by dynamically adapting to one or more unique behavioral patterns and preferences of individual users. In an embodiment, apparatus described herein may utilize one or more machine learning algorithms to analyze the collected user data, enabling it to make real-time decisions and adjustments. This ensures that the learning content and/or activity is presented in a desired manner that is conducive to the user's learning style, taking into account user's strengths, weaknesses, and specific needs. In another embodiment, aspects of present disclosure can provide educators with valuable insights into each student's progress and areas of improvement, facilitating a more personalized and effective teaching approach. Exemplary embodiments illustrating aspects of the present disclosure are described below in the context of several specific examples.

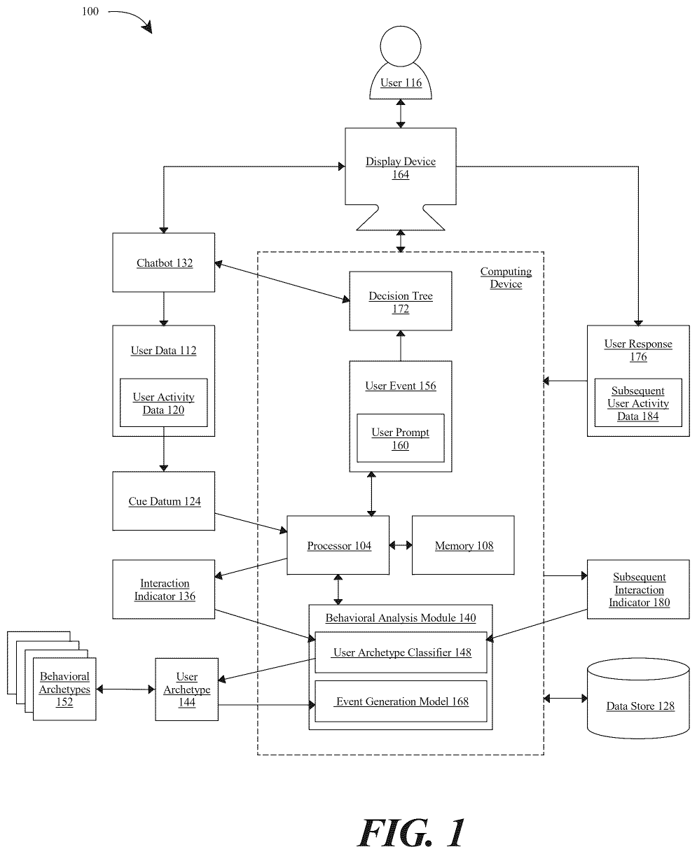

Referring now to FIG. 1, an exemplary embodiment of an apparatus 100 for assisted learning is illustrated. The apparatus 100 includes at least a processor 104. Processor 104 may include any computing device as described in this disclosure, including without limitation a microcontroller, microprocessor, digital signal processor (DSP) and/or system on a chip (SoC) as described in this disclosure. Processor 104 may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, processor 104 may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 1, apparatus 100 includes a memory 108 communicatively connected to processor 104, wherein the memory contains instructions configuring processor 104 to perform any processing steps as described in this disclosure. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a processor 104. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 is configured to receive user data 112 pertaining to a user 116. “User data,” as used herein, refers to any data, information, or signals associated with, or related to user 116. A “user,” as used herein, refers to any individual, entity, or system that interacts, communicates, or engages with apparatus 100. In some cases, user may include one or more students, parents, teachers, administrators, or any other stakeholder in an educational setting. In a non-limiting example, user 116 may include a student or learner who is the primary recipient of educational content or instruction delivered by apparatus 100. However, it should be noted that the term “user” is not limited to students and can encompass any individual or entity that utilizes the apparatus for any purpose. For example, and without limitation, in some embodiments, user 116 may include be an educator using the apparatus to monitor and assess one or more second users e.g., students' engagement and participation.

With continued reference to FIG. 1, in some cases, user data 112 may include, without limitation, personal information (e.g., user's name, email address, mailing/billing address, contact information, etc.), demographic information (e.g., age, gender, field of study, occupation, etc.), user preference data (e.g., preferred language, accessibility needs, interests, hobbies, etc.) among others. In a non-limiting example, if user 116 is defined as a non-native English speaker based on their demographic information and preferred language settings, in some cases, apparatus 100 may be configured to automatically adjust the content delivery to present information in the user's preferred language or offer additional language support tools such as real-time translations or subtitles.

Still referring to FIG. 1, in some embodiments, user data 112 may be collected and used by processor 104 to render a user model, wherein the “user model,” for the purpose of this disclosure, refers to a digital representation of user 116, In some embodiments, user model may be akin to a user account representing a real-world user in a digital environment as described in detail below. In some cases, user model may produce additional user data, or may be updated and refined based on additional user data. As a non-limiting example, additional user data may encompass account data such as username, password, privacy settings, notification preferences, and/or the like. If a user modifies one or more notification preferences in the system, such change may be reflected in user model, for instance, and without limitation, processor 104 may adjust frequency or method of communication between apparatus 100 and user model within the digital environment accordingly.

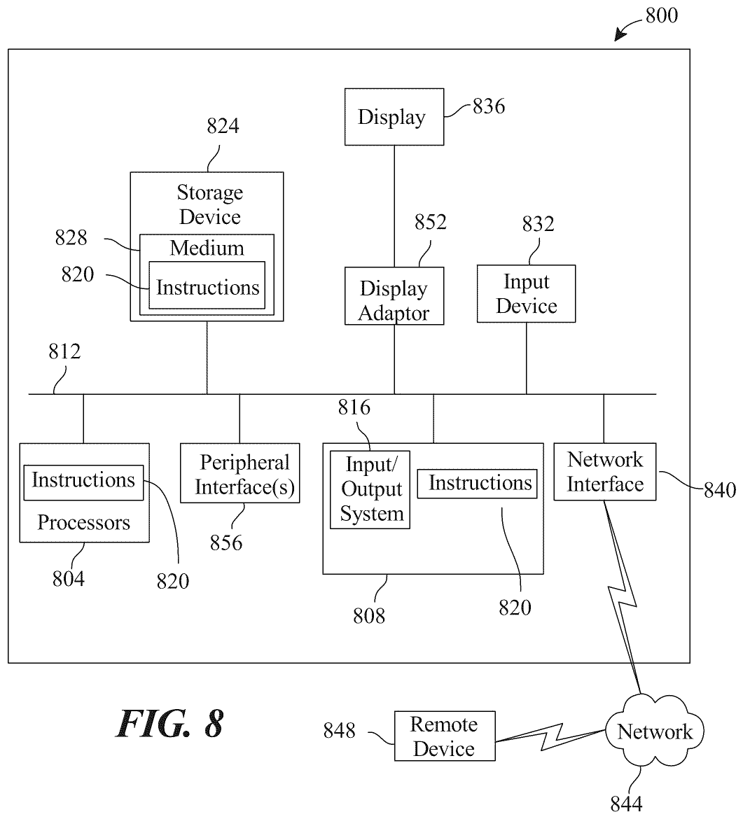

With continued reference to FIG. 1, a “digital environment,” for the purpose of this disclosure, refers to an integrated communications environment where a plurality of digital devices communicates and manage data and interactions within the said digital environment. In an embodiment, digital device may be any computing device as described in this disclosure, for example as described in FIG. 8. For example, digital environment may be one of a computer system, computer network, and the like. In an exemplary embodiment, digital environment may include a plurality of user devices interconnected with each other and processor 104 by one or more network interfaces as described above. As used in this disclosure, a “user device” is any additional computing device, such as a mobile device, laptop, desktop computer, or the like affiliated with user 116. In a non-limiting example, a digital device may include a computer and/or a smart phone operated by user 116 in communication with processor 104 at a remote location. In other embodiments, digital environment may also include any electronically based digital asset associated with digital environment; for instance, and without limitation, electronically based digital assets may include one or more computer programs, datasets, data stores, and the like.

Additionally, or alternatively, and still referring to FIG. 1, user model may be linked with third party platforms to provide a more holistic digital identity within digital environment as described above. In an embodiment, user data 112 may also incorporate data from other platforms or services user 116 associated with. In a non-limiting example, user data 112 may include additional user data such as social data (e.g., social connections, message data, posts, comments, shares, and/or the like) from platforms such as FACEBOOK, LINKEDIN, CANVAS, TWITTER, among others, providing insights into the user's 116 digital footprint and preferences in digital environment. Persons skilled in the art, upon reviewing the entirety of this disclosure, will be aware of various user data that can be collected and employed during further processing steps to enhance the functionality and accuracy of user model, all of which can be implemented in a manner consistent with this disclosure.

Continue referring to FIG. 1, user data 112 includes user activity data 120. As used in this disclosure, “user activity data” refers to a collection of data points describing one or more actions, interactions, and/or behaviors of user 116 while user 116 is using, interacting, and/or manipulating one or more digital systems, applications, websites, or otherwise services associated with apparatus 100 on which they are all implemented. In some cases, user activity data 120 may include, without limitation, mouse clicks, keystrokes, touch gestures, user requests or responses, or even more complex behaviors such as time spent on specific tasks, patterns of navigation, content consumption habits, and/or the like.

Still referring to FIG. 1, in one embodiment, user activity data 120 may include one or more data points capture the manipulation of user model as described above, for example, and without limitation, frequency and duration of user logins. In such an embodiment, user activity data 120 may provide insights into at least one aspect of user's 116 engagement level with integrated platform. In a non-limiting example, user 116 logging in daily and/or spending extended periods may indicate a relatively high engagement level, while sporadic, brief logins by may suggest the opposite.

Still referring to FIG. 1, in another embodiment, user activity data 120 may include data related to user's interactions with multimedia content. In some cases, multimedia content may include educational content delivered by apparatus 100. In a non-limiting example, user activity data 120 may include data generated via tracking specific video user 116 watches, duration for which user 116 watched, and/or any interactions user 116 have with the content such as pausing, rewinding, adjusting volume levels, commenting, like or dislike, among others.

Still referring to FIG. 1, yet in another embodiment, user activity data 120 may include data related to user's 116 interactions in a collaborative environment, for example, and without limitation, a digital workspace (i.e., an integrated framework within digital environment that centralizes the management of data, applications, and/or desktop delivery). In some cases, digital workspace may include, without limitation, one or more combination of various tools and platforms such as collaboration software, cloud storage solutions, virtual desktop infrastructures, enterprise applications, and/or the like into a cohesive digital environment. In a non-limiting example, user activity data 120 may include document interaction, application usage, calendar data, collaboration metrics, device information and/or the like.

Furthermore, and still referring to FIG. 1, in an educational setting e.g., a learning management system, user activity data 120 may also include user's 116 (e.g., student's) progress through delivered content such as course materials, user's 116 performance on assessments such as periodic quizzes and exams, user's participation in discussion forms, among others. As a non-limiting example, user activity data 120 may identify student frequently accessed remedial materials or time spent on certain topics. If user 116 access remedial materials exceed certain threshold or time spend longer than average on certain topics, such user activity data 120 tracked by processor 104 may indicate areas/topics user 116 is currently struggling.

With continued reference to FIG. 1, as a non-limiting example, user data 112 may be associated with a discussion topic, wherein the “discussion topic,” for the purpose of this disclosure, is a subject for users to discuss and be evaluated on. For example, and without limitation, discussion topic may include a particular chapter from a book, a particular mathematical concept, a particular historical figure, or the like. In an embodiment, user activity data 120 incorporated within such user data 112 may include one or more discussion datums. As used in this disclosure, a “discussion datum” refers to an audio recording of user discussion in response to one or more prompts, a datum derived from the audio recording of user discussion in response to the one or more prompts, or both. In a non-limiting example, and without limitation, discussion topic and/or discussion datum described herein may be consistent with any discussion topic and/or discussion datum disclosed in U.S. application Ser. No. 18/543,458, filed on Dec. 18, 2023, entitled “SYSTEMS AND METHODS FOR ARTIFICIAL INTELLIGENCE-MEDIATED MULTIPARTY ELECTRONIC COMMUNICATION,” which entirety is incorporated by reference herein.

With continued reference to FIG. 1, in some embodiments, user activity data 120 may include at least one cue datum 124. As used in this disclosure, a “cue datum” refers to a specific piece of information or signal that triggers a particular action or response within the system. In some cases, cue datum 124 may be derived from the user's interactions, preferences, or behaviors within the digital environment. For instance, and without limitation, cue datum 124 may be generated, by processor 104, when a user spends an extended period on a particular task, indicating potential difficulty or heightened interest. Alternatively, cue datum 124 may include one or more specific semantic unit, for example, without limitation, a keyword or phrase used by the user in a search, a command, a response, and/or the like, signaling a specific intent or request.

In one or more embodiments, and still referring to FIG. 1, cue datum 124 may include a data element representing user's 116 repeated access to a specific module or tool within the digital workspace, suggesting a preference or reliance on the module or the tool. In another embodiment, cue datum 124 may be generated based on the frequency of interactions with a particular piece of delivered content, indicating its relevance or importance to user 116. Additionally, or alternatively, cue datum 124 may also be derived, by processor 104, from passive interactions related to user 116. As a non-limiting example, such cue datum 124 may include passive interaction metrics such as duration of inactivity, system I/O status, idle time, background application usage, and/or the like. Processor 104 may continuously monitor user activities and log one or more passive interactions listed above. For instance, passive interaction metric e.g., a prolonged duration of inactivity may serve as a “cue” for apparatus 100 when it matches or exceeds a predefined threshold. Processor 104 may recognize such cue datum 124 to check in on user 116 or offer assistance. In a non-limiting example, if user 116 remains inactive for a prolonged period during a timed assessment, a cue datum may be generated, prompting processor 104 to send a reminder or offer help to user 116.

With continued reference to FIG. 1, one or more event listeners may be employed by processor 104 to monitor user data 112 including, without limitation, user activity data 120 and/or at least one cue datum 124 described herein. As used in this disclosure, “event listeners” refers to scripts or tools that actively wait (or await) for a specific action to occur, for example, and without limitation, a mouse clicks, a key press, a user input, and/or the like and then capture that action's details. In an embodiment, event listeners may be implemented using JavaScript or similar scripting languages to detect user interactions with a web-based environment; for example, and without limitation, an event listener may be registered, by processor 104, to one or more visual elements on user interface as described in detail below via one or more event targeting application programming interface (API) such as “.on,” “.addEventListener,” “.attachEvent,” and/or the like. In a non-limiting example, an event listener may be configured to detect when a user pauses a video and log that action. Such event listener may be linked, by processor 104, to a “play” button associated with the video.

Still referring to FIG. 1, in some cases, processor 104 may utilize one or more “web beacons,” i.e., small transparent images embedded in delivered content e.g., web pages, (also known as pixel tags or clear GIFs), when loaded, send data such as user activity data 120 back to a server. In an embodiment, web beacon may be used to track user interactions and behaviors on a page, such as which sections of a page were viewed; for instance, and without limitation, this may be achieved by embedding multiple beacons at different sections of the page. When a user scrolls and views a section, the corresponding beacon may be loaded, sending a signal back to processor 104.

Continued referring to FIG. 1, web beacons may be used in conjunction with one or more cookies (i.e., small pieces of data stored on user device described herein that can track user activity data 120 across different sessions) to gather more personalized user data 112. In an embodiment, a cookie may store a timestamp of the last video watched, allowing apparatus to resume playback from that point in the next session. In a non-limiting example, if user 116 has previously provided certain information such as, user's current location or user preferences pertaining to user 116, a cookie may store such data. When user 116 later visits a page with one or more web beacons, at least one web beacon may access the cookie and send the combined data e.g., both the stored preferences and the current activity detail back to processor 104 for one or more further processing steps as described in detail below.

With continued reference to FIG. 1, in some cases, user data 112 including, without limitation, user activity data 120 and cue datum 124 may be extracted, by processor 104, from one or more server logs. “Server logs,” for the purpose of this disclosures, are documentations (i.e., files) where the server records all communications between user 116 and processor 104 e.g., all requests made to processor 104. In some cases, server logs may include, without limitation, IP address from which the requests originated, timestamps of the requests, type of requests, status code returned, among others. In an embodiment, server logs may be parsed and analyzed in real-time to extract relevant user data 112 described herein. In a non-limiting example, processor 104 may be configured to filter out one or more log entries containing user activity data 120 based on one or more predefined criteria (e.g., conditional statements established based on data entries having at least a heading or a tag equal to “user_activity”). Additionally, or alternatively, server logs may be stored in a structured database format (as described in detail below), allowing for complex querying and data extraction operations. For instance, and without limitation, SQL queries may be used to retrieve specific user interactions over a given time period.

With continued reference to FIG. 1, one or more API calls, made by processor 104, may allow for user data 112, user activity data 120, and/or cue datum 124 retrieval. In some embodiments, APIs such as, without limitation, RESTful APIs, GraphQL, WebSockets, OAuth, and/or the like may be employed to enable seamless data retrieval. In a non-limiting example, one or more API described herein may be used to fetch any data described herein from a remote data store 128. In some cases, the data store 128 may be implemented, without limitation, as a relational database, a key-value retrieval database such as a NOSQL database, or any other format or structure for use as a database that a person skilled in the art would recognize as suitable upon review of the entirety of this disclosure. Data store 128 may alternatively or additionally be implemented using a distributed data storage protocol and/or data structure, such as a distributed hash table or the like. Data store 128 may include a plurality of data entries and/or records as described above. Data entries in data store 128 may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries may store, retrieve, organize, and/or reflect data and/or records as used herein, as well as categories and/or populations of data consistently with this disclosure.

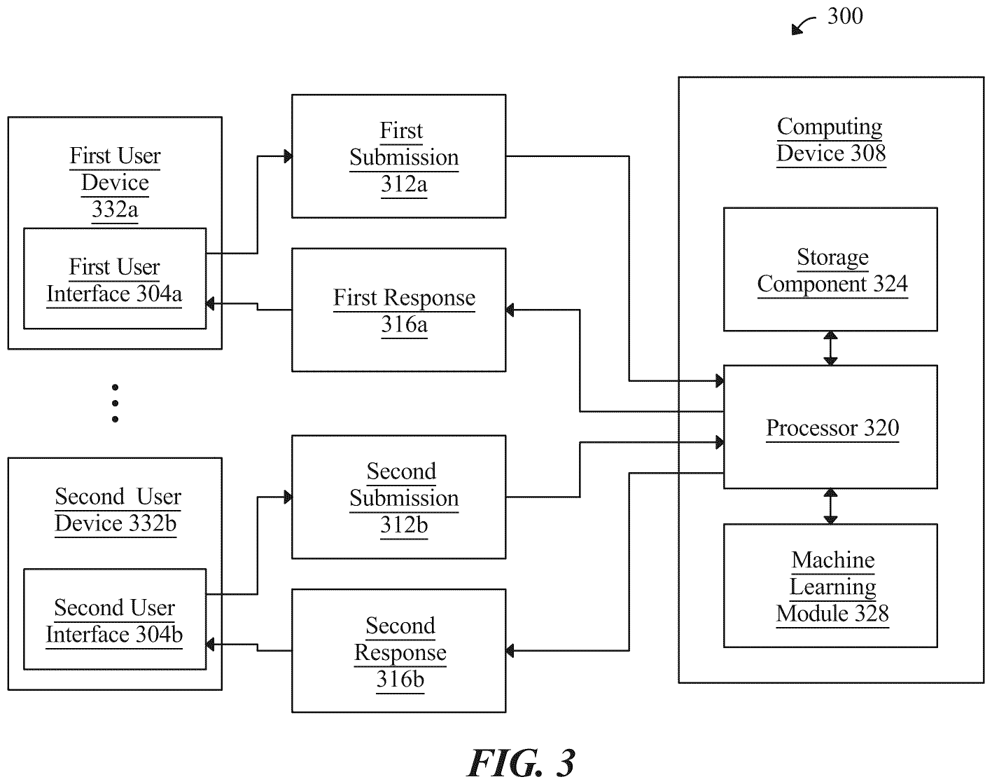

With continued reference to FIG. 1, user data 112, user activity data 120, and/or cue datum 124 may be also received using a chatbot 132. As used in this disclosure, a “chatbot” is a software application designed to simulate human conversation, either through text or voice interactions, using a set of predefined rules, one or more machine learning algorithms, or a combination of both. In an embodiment, user activity data 120 may include user input, for example, and without limitation, text messages, voice commands, user queries, user feedback or responses such that real-time or historical conversational data may be received using chatbot 132. In another embodiment, chatbot 132 may be configured to proactively engage with user 116, prompting user 116 with one or more questions, providing suggestions, or guiding user 116 through specific tasks based on the context of the conversation including user data 112 and/or user activity data 120 submission. Such submission may be implicit, which means that chatbot 132 may derive or infer user activity data 120 such as, without limitation, data describing user activities, intentions, preferences, or otherwise needs without explicit directives from user 116, based on user inputs and/or historical (i.e., previous) user inputs. In a non-limiting example, user 116 e.g., a student may interact with chatbot 132 to seek clarification on a topic, and chatbot 132, using a knowledge base, may be configured to provide one or more tailored explanations or resources to assist student's understanding on the topic. Processor 104 may record the conversation between student and chatbot 132 as user activity data 120. Chatbot 132 is described in detail below with reference to FIG. 3.

With continued reference to FIG. 1, other exemplary embodiments of user activity data 120 may include, without limitation, historical interaction records, user feedbacks, location data, download histories, search queries, bookmarked content, shared content, and/or the like. Additionally, or alternatively, user activity data 120 may optionally encompass biometric data such as, without limitation, facial recognition patterns, voice commands, fingerprint scans used for user authentication and/or any validation or verification. Further, user activity data 120 may also capture environmental data, such as, without limitation, environmental noise, ambient light, or device orientation, to understand user's context better. In some cases, processor 104 may communicate with one or more sensors and/or receiving devices as described herein to receive environmental data.

In one or more embodiments, and still referring to FIG. 1, apparatus 100 may include a microphone. As used in this disclosure, a “microphone” is any transducer configured to transduce pressure change phenomenon to a signal, for instance a signal representative of a parameter associated with the phenomenon. A microphone, according to some embodiments, may include a transducer configured to convert sound into electrical signal. Exemplary non-limiting microphones include dynamic microphones (which may include a coil of wire suspended in a magnetic field), condenser microphones (which may include a vibrating diaphragm condensing plate), and a contact (or conductance) microphone (which may include piezoelectric crystal material). In some cases, receiving user data 112 pertaining to user 116 may include receiving one or more audio signals using microphone described herein. An “audio signal,” as used in this disclosure, is a representation of sound. In a non-limiting example, audio signal may include user's 116 voice command or query, which may be processed and analyzed by processor 104 to provide relevant feedback, answer questions, or trigger specific actions described herein based on the delivered content and/or context of the audio input.

Still referring to FIG. 1, in some cases, receiving audio signal as user data 112 may include performing an automatic speech recognition on received audio signal. In some embodiments, automatic speech recognition may require training (i.e., enrollment). In some cases, training in an automatic speech recognition model may require an individual speaker to read text or isolated vocabulary. In some cases, a solicitation video may include an audio component having an audible verbal content, the contents of which are known apriori by processor 104. Processor 104 may then train an automatic speech recognition model according to training data which includes audible verbal content correlated to known content. In this way, processor 104 may analyze a user's specific voice and train an automatic speech recognition model to the person's speech, resulting in increased accuracy. Alternatively, or additionally, in some cases, processor 104 may include an automatic speech recognition model that is speaker-independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” refers to identifying a speaker, from audio content, rather than what the speaker is saying. In some cases, processor 104 may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within solicitation video, but others may speak as well.

Still referring to FIG. 1, in some embodiments, an automatic speech recognition process may include one or more of acoustic modeling, language modeling, and statistically-based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MHLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum aposteriori probability estimates of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighed by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used as an automatic speech recognition process to cope with different speaking (i.e., audible verbal content) speeds. In some cases, DTW may allow processor 104 to find an optimal match between two given sequences (e.g., time series) with certain restrictions. That is, in some cases, sequences can be “warped” non-linearly to match each other. In some cases, a DTW-based sequence alignment method may be used in context of hidden Markov models.

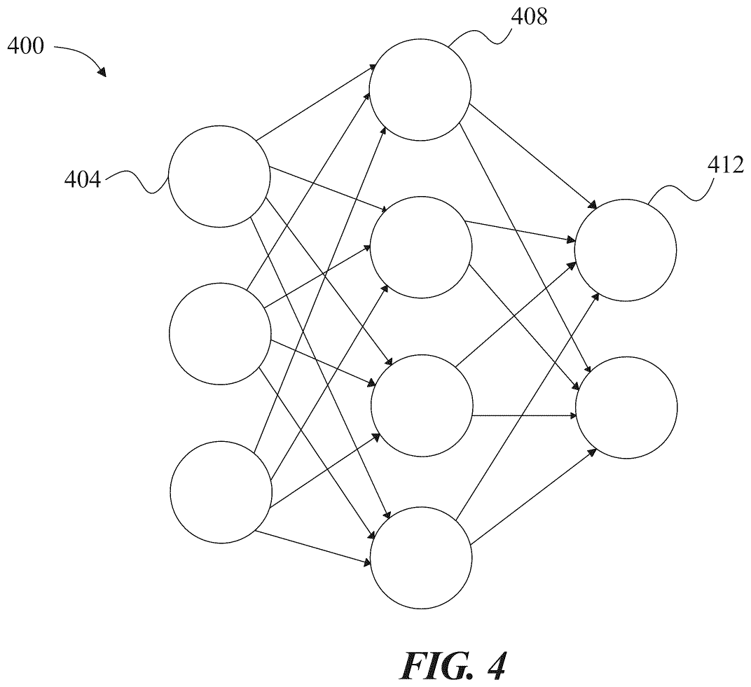

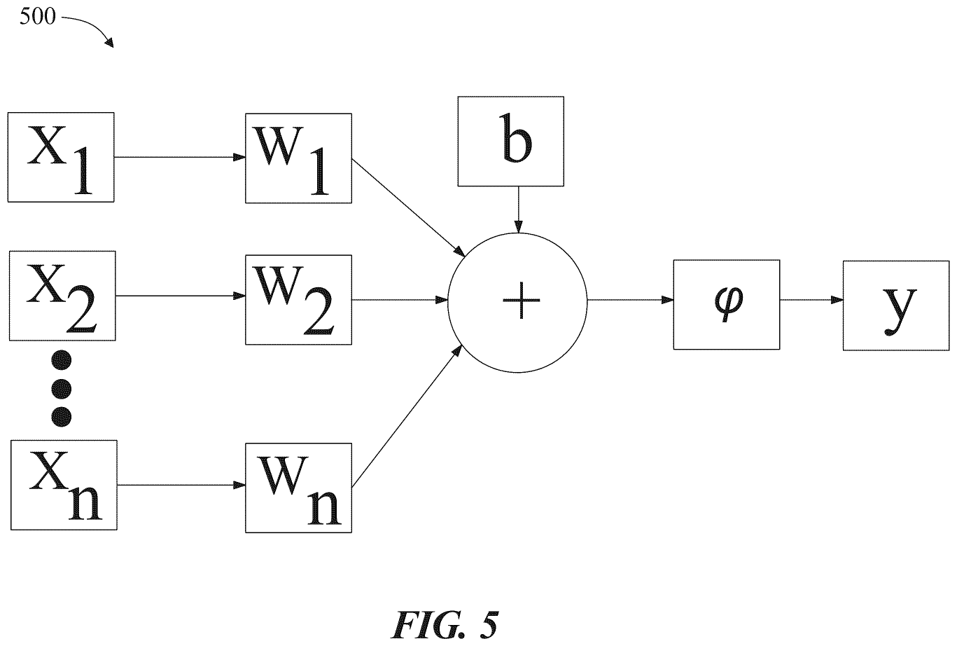

Still referring to FIG. 1, in some embodiments, an automatic speech recognition process may include a neural network. Neural network may include any neural network, for example those disclosed with reference to FIGS. 4-5. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time intervals, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

With continued reference to FIG. 1, in other embodiments, apparatus 100 may include one or more optical sensors, such as cameras, communicatively connected to processor 104, configured to receive imagery user data, wherein the imagery user data may include visualized user data 112 as described above, for example, and without limitations, user data 112 in an image format. In some cases, optical sensors such as, without limitations, digital image sensors, charge-coupled device (CCD) sensors, complimentary metal-oxide-semiconductor (CMOS) sensors, chemical image sensors, analog image sensors, among others may capture real-time video feeds, still photographs, or even infrared or ultraviolet imagery. In a non-limiting example, imagery user data may include facial features for facial recognition, gestures for gesture-based controls, or even scanning QR codes or barcodes for user data retrieval.

With continued reference to FIG. 1, in some cases, processor 104 may include an implementation of a computer vision model configured to process, analyze, and/or interpret imagery user data as described above. A “computer vision model,” for the purpose of this disclosure, is a computation model designed to interpret and make determinations based on visual data. In an embodiment, computer vision model may process imagery user data such as, facial features, object contours, color patterns, user motion, or depth of information, to identify (visual) cue datums 124 such as, user emotions, specific gestures, presence of particular objects, changes in lighting conditions, proximity of objects to user, or user's focus of attention within imagery user data. One or more CV algorithms, including but not limited to convolution neural networks (CNNs), edge detection, feature extraction, and/or the like as described in detail below with reference to FIGS. 4-5 may be utilized by processor 104 for such purposes.

In some cases, and still referring to FIG. 1, apparatus 100 may be implemented as an augmented reality applications, where an “augmented reality (AR) device,” as used herein, a device that permits user 116 to view a typical field of vision and superimposes virtual images on the field of vision, (e.g., ranged from AR glasses or headsets to user devices such as smartphones and tablets equipped with AR capabilities) may be used to capture user's field of view, facilitated interactive learning experiences; for instance, and without limitation, a student (i.e., user 116) studying anatomy may see a 3D model of the human body superimposed over a study partner (i.e., a second user), allowing both students to interactively explore various organs and systems. In some cases, microphone described above may be used to capture discussion between student and the study partner as user activity data 120 and transmitted to processor 104.

As a non-limiting example, and still referring to FIG. 1, user data 112 may include a handwritten note, wherein the handwritten note may be presented, by user 116, to a camera, and processor 104 may be configured to employ optical character recognition (OCR) techniques to automatically convert the handwritten text (i.e., images) into digital format for further processing as described below. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases OCR may be an “offline” process, which analyses a static document or image frame. In some cases, handwriting movement analysis can be used as input to handwrite recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases, a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

Still referring to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

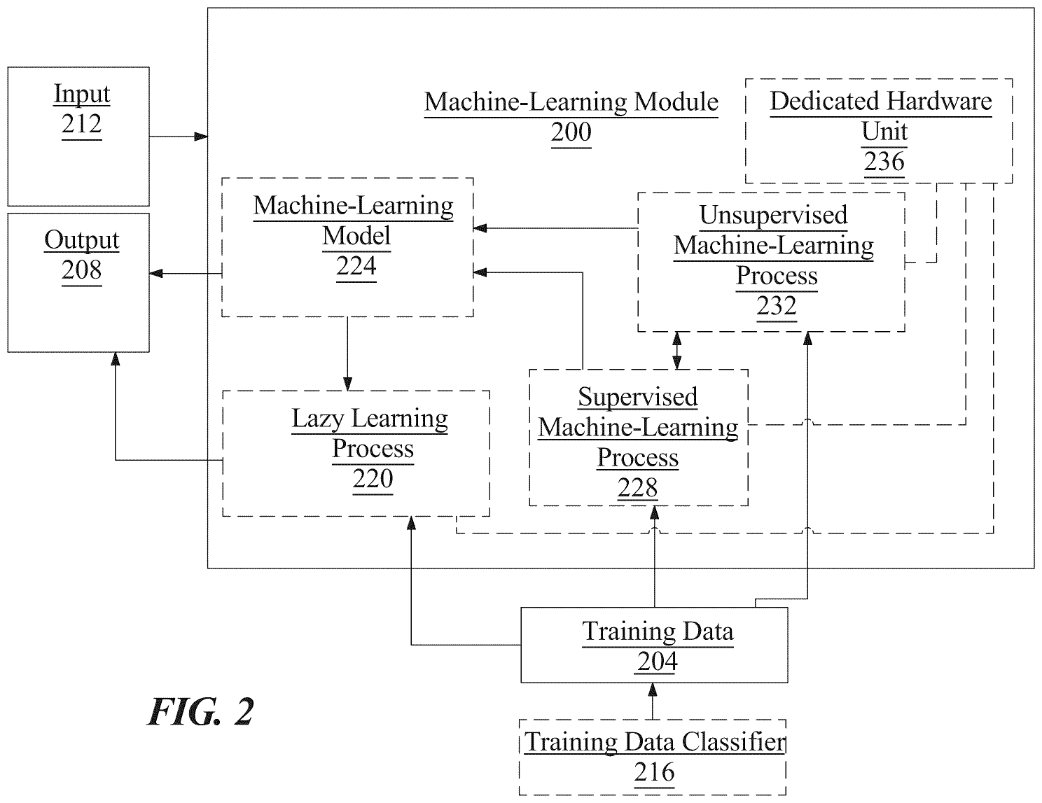

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted features can be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors' algorithm) can be used to compare image features with stored glyph features and choose a nearest match. OCR may employ any machine-learning process described in this disclosure, for example machine-learning processes described with reference to FIG. 2 below. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool includes OCRopus. OCRopus development is led by German Research Centre for Artificial Intelligence in Kaiserslautern, Germany. In some cases, OCR software may employ neural networks, for example neural networks as taught in reference to FIGS. 4-5 below.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of apriori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, user data 112 including user activity data 120, cue datum 124, and any relevant information described herein, regardless of their input/output (IO) format, may be represented as a vector, wherein the “vector,” as defined in this disclosure, is a data structure that represents one or more a quantitative value and/or measures of data described herein. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other.

In a non-limiting example, user data vector v may incorporate user activity data vector u, wherein each element of user activity data vector u may represent a specific user activity. In some cases, a user activity data vector u may include, without limitation, three activities, such as, frequency of logins, duration of interactions, and number of items clicked. Such user's activity data vector u may be represented as u=[f, d, c], where f is the frequency of logins, d is the total duration of interactions, and c is the count of items clicked. Continuing the non-limiting example, a cue datum may include a subset of user activity data vector u (i.e., sub-vector) or a differentiation of user activity data vector u. For instance, and without limitation, processor 104 may generate a cue datum vector w based on a plurality of user activity data vectors arranged in a chronological order, wherein the cue datum vector w may capture a “rate of change” or a “sudden change” in user activities. In some cases, cue datum vector w may be represented as w=[Δf, Δd, Δc], wherein Δf, Δd and Δc are the changes in frequency of logins, duration of interactions, and count of items clicked, respectively, over a specific time interval. In a non-limiting example, if user 116 suddenly increases login frequency but reduces interaction duration, cue datum vector w may capture these changes as significant change, potentially indicating a shift in user behavior or a response to a specific event or feature in digital environment.

With continued reference to FIG. 1, processor 104 is configured to determine an interaction indicator 136 by evaluating user activity data 120 using a behavioral analysis module 140. As used in this disclosure, an “interaction indicator” refers to a metric or set of metrics derived from the user's interactions. In some cases, interaction indicator 136 may include one or more values or data elements related to user's 116 preferences, engagement level, responsiveness, or behavioral patterns in digital environment. In an embodiment, interaction indicator may include one or more values or data elements derived from user activity data 120, for example, and without limitation, frequency of interactions, duration of interactions, patterns of navigation (within the digital environment), and/or any combination thereof. In a non-limiting example, if a student frequently pauses and rewinds a particular video lecture, interaction indicator may flag such behavior, suggesting the student is finding that section challenging.

Additionally, or alternatively, and still referring to FIG. 1, processor 104 may determine interaction indicator 136 as a function of cue datum 124. In an embodiment, cue datum 124 may serve as a trigger or marker that highlight specific user actions or behaviors; for instance, and without limitation, a cue datum may be a specific keyword used in a chat or a particular gesture made in a virtual classroom (AR setting). Processor may be configured to utilize one or more machine learning models as described in detail below to analyze the relationship between cue datum 124 and derived interaction indicator 136. In a non-limiting example, if a user frequently hovers over a link to an online course (i.e., cue datum 124) but does not click on it, an interaction indicator may be determined, by processor 104, suggesting the user is “interested but uncertain.” Apparatus 100 may then be configured to proactively list the online course on top of the page or even offer a discount or additional information about the online course to encourage enrollment.

With continued reference to FIG. 1, determining interaction indicator 136 may include scoring and/or ranking user activity data 120. In a non-limiting embodiment, user activity data 120 may include a plurality of data entries (or data elements), wherein each data entry of the plurality of data entries contains information related to an action, a set of behaviors, or a specific interaction between a plurality of users and/or digital environment. Determining interaction indicator 136 may include assigning a score (e.g., a numerical score) to each data entry of plurality of data entries. In some cases, scores may be calculated by processor 104, using a pre-defined scoring function. In a non-limiting example, scoring function may take factors within each data entry such as frequency f, duration d, and significance s of an interaction i into account, and outputs a weighted score W(i).

$$W ( i ) = α \cdot f + β \cdot d + γ \cdot s ( i )$$

Wherein α, β, and γ are weighting coefficients that determine the importance of each factor in the overall score. In some cases, weighting coefficients may be determined by evaluating historical user data using behavioral analysis module 140 and/or one or more machine learning models as described in detail below. In other cases, weighting coefficients may be also determined according to user feedback within received user data 112 as described above.

In a non-limiting example, and still referring to FIG. 1, in a e-learning platform, duration d may be given more weight (β) as spending more time on a topic could indicate user's 116 interest or difficulty in understanding the topic. Conversely, for taking (online) courses under a synchronous setting, frequency (of asking and/or answering questions in class) f may be prioritized (α) as frequent interactions could denote user engagement and/or satisfaction corresponding to the courses. Additionally, or alternatively, weighting coefficient may be dynamically adjusted based on real-time feedback loop(s) as described below, wherein processor 104 may be configured to continually refine one or more weights to better align with user preferences/behaviors or any desired output. One or more machine learning models may be employed by processor 104 to automatically calibrate weighting coefficients described herein based on historical user data, ensuring interaction indicator 136 remains representative of user's 116 actual behavior described by user activity data 120.

With continued reference to FIG. 1, in some cases, scores associated with user activity data 120 may be averaged, normalized and/or aggregated to derive a composite score that represents the overall interaction level of user 116. In an embodiment, each data entry may be “normalized,” or divided by a “length” attribute, such as a length attribute 1 as derived using a Pythagorean norm:

$$l = \sqrt{{\sum }_{i = 0}^{n} {a}_{i}^{2} ,}$$

where aᵢ is attribute number i of the data entry in vector form. In a further embodiment, composite score may be used by processor 104, to categorize or rank the user's 116 engagement level, responsiveness, or preference in digital environment. In other cases, one or more pre-determined thresholds may be set to classify user data 112 into different user categories based on the corresponding composite scores. In a non-limiting example, if a user frequently visits a specific section of an e-textbook and spends considerable time (i.e., first pre-determined threshold) on certain topics (i.e., second pre-determined threshold, represented by high scores for those specific data entries), composite score may indicate a strong interest or difficulty in that area.

With continued reference to FIG. 1, a “behavioral analysis module,” as described herein, refers to a computational component or subsystem designed to evaluate, interpret, and/or analyze data such as, without limitation, user activity data 120 to derive insights into the user's behavior and/or behavior patterns. In one embodiment, behavioral analysis module 140 may utilize one or more statistical methods such as, without limitation, regression analysis, clustering, and/or principal component analysis (PCA), to identify user's 116 behavior patterns or trends in the user's interactions over time. In a non-limiting example, behavioral analysis module 140 may employ time series analysis to understand the periodicity of user activity data 120, identifying behavioral patterns such as “daily,” or “weekly” cycles. In another non-limiting example, behavioral analysis module 140 may include implementation of sentiment analysis on textual inputs as described in detail below to gauge user's emotional state or mood over time. For instance, and without limitation, if a user consistently provides feedback or comments with negative sentiment, processor 104 may generate interaction indicator 136 indicating dissatisfaction or frustration. Similarly, behavioral analysis module 140 may further analyze a velocity of user interactions, for example, and without limitation, the speed of scrolling or the rapidity of keystrokes, to infer levels of engagement or urgency. In yet another embodiment, behavioral analysis module may evaluate a spatial distribution of user's clicks or touches on a screen to understand areas of interest or confusion in user interface displaying the delivered content.

With continued reference to FIG. 1, behavior analysis module 140 may include a machine learning module to implement one or more algorithms or generate one or more machine learning models to determine interaction indicator 136 as described above. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from data store 128 as described herein or any other databases, or even be provided by user 116. In a non-limiting example, machine-learning module may obtain a training set by querying data store 128 that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. In a further embodiment, training data may include previous outputs such that one or more machine learning models iteratively produces outputs.

With continued reference to FIG. 1, in one or more embodiments, interaction indicator 136 may include one or more data elements describing projected user actions and/or behaviors. Behavior analysis module 140 may utilize one or more machine learning models generated by machine learning module described above to predict future user actions based on their past behavior. In a non-limiting example, processor 104 may generate and train an action projection model using action projection training data, wherein the action projection training data may include a plurality of user activity data sets as input correlated to a plurality of labels related to projected user actions as output. Processor 104 may then generate interaction indicator as a function of user data 112 using trained action projection model based on projected user actions. For example, and without limitation, if user 116 frequently accesses content related to a specific topic, apparatus 100 may anticipate user's 116 interest in upcoming content on the same topic.

With continued reference to FIG. 1, in some cases, determining interaction indicator 136 may include identifying a user archetype 144 based on user activity data 120. As used in this disclosure, a “user archetype” refers to a category or profile that represents a specific type or group of users exhibiting similar behavioral patterns, preferences, or characteristics within digital environment. In a non-limiting example, user archetype 144 may be an “Engaged Learner,” wherein the “engaged learner” user archetype may represent users who frequently interact with content, participate in discussions, and/or complete tasks or assignments on time. User activity data 120 associated with such user archetype may show, without limitation, consistent logins, high session durations, regular interactions with a plurality of features (e.g., APIs) of the platform. In another non-limiting example, user archetype 144 may also include a “Casual Browser” archetype. In some cases, users associated with such user archetype may sporadically engage with content, often skimming through materials without deep dives; for instance, and without limitation, user activity data 120 associated with these users may indicate shorter session durations, infrequent logins, and/or interactions mainly with introductory or summary sections of content. In a further non-limiting example, user archetype 144 may describe one or more users as “collaborative participant,” wherein the users fit such user archetype may actively participating in group discussions, sharing resources, and/or seeking feedback. Their user activity data 120 may show frequent use of communication tools, multiple interactions with peers, and/or uploads/downloads of shared resources. As an ordinary person skilled in the art, upon reviewing the entirety of this disclosure, will be aware of various user archetypes that may be derived, adapted, or expanded upon based on the specific nuances of user behaviors in consistent with the current disclosure.

With continued reference to FIG. 1, in some cases, identifying user archetype 144 may include generating a user archetype classifier 148. A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Processor 104 and/or machine learning module as described above may generate user archetype classifier 148 using a classification algorithm, defined as a process whereby processor 104 and/or machine learning module derives a classifier from training data. In some cases, classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In a non-limiting example, generating user archetype classifier may include training user archetype classifier 144 using user archetype training data, wherein the user archetype training data may include a plurality of user activity data sets as input correlated to a plurality of pre-defined user archetypes as output, and classifying user activity data 120 into at least one user archetype 144 using trained user archetype classifier 144.

Still referring to FIG. 1, in a non-limiting embodiment, processor 104 may be configured to generate user archetype classifier 148 using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data such as, without limitation, user archetypes 144; this may be performed by representing both training data and input data in vector forms as described above, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

Yet in another embodiment, and still referring to FIG. 1, behavioral analysis module 140 may be operatively connected with a language processing module, integrate sentiment analysis to gauge the user's 116 emotional response to content and identify user archetype 144 as a function of the user's 116 emotional response. Processor may configure language processing module to analyze textual inputs, comments, user feedbacks, or any form of written communication from user 116, and then discern one or more underlying sentiment units such as “happiness,” “frustration,” “confusion,” or “satisfaction.” In some embodiments, these sentiment units may be mapped to specific emotional profiles corresponding to different user archetypes. In a non-limiting example, user 116 expressing consistent satisfaction may be categorized under a “satisfied” user archetype, while those expressing confusion may fall under a “seeker” user archetype.

With continued reference to FIG. 1, language processing module may include any hardware and/or software module. Language processing module may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Still referring to FIG. 1, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to 1, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs, as used herein are statistical models with inference algorithms that that may be applied to the models. In such models, a hidden state to be estimated may include an association between an extracted word, phrases, and/or other semantic units. There may be a finite number of categories to which an extracted word may pertain; an HMIM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity as described in detail below, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or processor 104 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

With continued reference to FIG. 1, in one or more embodiments, determining interaction indicator 136 further includes validating user archetype 144 against a pre-defined set of behavioral archetypes 152. As used in this disclosure, “pre-defined set of behavioral archetypes” represents a collection of established patterns of user behavior, preferences, and interactions described herein that have been identified and categorized. In some cases, pre-defined set of behavioral archetypes may be initialized and expanded by professionals such as, without limitation, psychologist, behavioral scientists, experienced researchers, data analysts, sociologists, and/or the like. In other cases, pre-defined set of behavioral archetypes may be initialized based on, or extracted from, a plurality of corpora such as, without limitation, user interaction logs, social media activity datasets, scientific research papers, historical user behavior databases, and/or the like. Alternatively, a domain-specific knowledge based may be established, by processor 104, configured to define, refine, and/or categorize behavioral archetypes based on observed patterns and theoretical frameworks. In a non-limiting example, each behavioral archetype within pre-defined set of behavioral archetypes may have a corresponding data structure containing a unique set of characteristics, behaviors, and tendencies; for instance, and without limitation, each behavioral archetype may reference a dictionary containing a plurality of key value pairs e.g., “<key, value>,” wherein each key value pairs of the plurality of key value pairs may described a unique characteristic, property, or attribute associate with a particular behavioral archetype within pre-defined set of behavioral archetypes.

As used in this disclosure, and still referring to FIG. 1, “validation” is a process of ensuring that which is being “validated” complies with stakeholder expectations and/or desires. Stakeholders may include users, administrators, property owners, customers, and the like. Very often a specification prescribes certain testable conditions (e.g., metrics) that codify relevant stakeholder expectations and/or desires. In some cases, validation includes comparing a product, for example without limitation user archetype 144 against a specification. In some cases, processor 104 may be additionally configured to validate a product by validating constituent sub-products. In some embodiments, processor 104 may be configured to validate any product or data, for example without limitation user archetype 144. In some cases, at least a machine-learning process, for example a machine-learning model as described herein, may be used to validate by processor 104. Processor 104 may use any machine-learning process described in this disclosure for this or any other function.

With continued reference to FIG. 1, in some embodiments, validation process may involve calculating a similarity metric between user archetype 144 and each behavioral archetype in pre-defined set of behavioral archetypes 152, wherein the “similarity metric,” for the purpose of this disclosure, refers to a computational representation of a degree of similarity or likeness between two objects or data points. In an embodiment, such similarity metric may be calculated within a vector space, wherein each archetype (e.g., user archetype 144, each behavioral archetype within pre-defined set of behavioral archetypes 152) may be represented as a vector. In such an embodiment, any two orthogonal vectors may define a two-dimensional subspace within the vector space. A magnitude or a vector's “norm’ (i.e., a scalar value) may provide a measure of its length or size. For an n-dimensional vector, denoted as a, its norm, represented as ∥a∥ may be defined, without limitation, as follows:

$$‖ a ‖ = \sqrt{{\sum }_{i = 0}^{n} {a}_{i}^{2}}$$

Processor 104 may be further configured to compare calculated similarity metric against a pre-determined threshold to determine an alignment or match between user archetype 144 and one or more behavioral archetypes within pre-defined set of behavioral archetypes 152. In a non-limiting example, if similarity metric exceeds or meets the threshold, it may indicate a strong correlation or match between user activity data 120 and/or cue datum 124 and a specific user archetype. Conversely, if similarity metric falls below the threshold, it may suggest a weaker correlation or potential misalignment.

Still referring to FIG. 1, each behavioral archetype within the pre-defined set of behavioral archetypes 152 can be conceptualized as a dimension within a vector space. For illustration, each element of a vector might represent the frequency or enumeration of co-occurrences of specific user behaviors, actions, or activities associated with that particular archetype. This representation can be further enriched with attributes like the intensity, duration, or context of the behavior. On the other hand, not all dimensions of this vector space need to correspond directly to distinct behavioral archetypes. Some dimensions may capture composite or hybrid behaviors, where elements of a vector signify a combination of behaviors. In some cases, these elements may have numerical values that depict a geometrical relationship with the vector representing user archetype 144. Such geometrical relationship may, for instance, indicate a proximity or similarity between behavioral archetype and user archetype 144. In a non-limiting example, two vectors may be generally considered more similar if they point in closer directions and less similar if their directions diverge. However, the measure of vector similarity, or the similarity metric, may also be derived from averaging the similarities of corresponding attributes, or it could be based on other mathematical models suitable for comparing n-tuples of values, ensuring a comprehensive understanding of user behavior.

With continued reference to FIG. 1, any vectors as described herein may be scaled, such that each vector represents each user/behavioral archetype along an equivalent scale of values. In an embodiment validating user archetype against pre-defined set of behavioral archetypes 152 as described above may include computing a degree of vector similarity (i.e., similarity metric) between a vector representing each behavioral archetype of pre-defined set of behavioral archetypes 152 and a vector representing user archetype 144; vector similarity may be measured according to any norm for proximity and/or similarity of two vectors as described herein, including without limitation, a cosine similarity. As used in this disclosure “cosine similarity” is a measure of similarity between two-non-zero vectors of a vector space, wherein determining the similarity includes determining the cosine of the angle between the two vectors. Cosine similarity may be computed as a function of using a dot product of the two vectors divided by the lengths of the two vectors, or the dot product of two normalized vectors. For instance, and without limitation, a cosine of 0° is 1, wherein it is less than 1 for any angle in the interval (0, π) radians. Cosine similarity may be a judgment of orientation and not magnitude, wherein two vectors with the same orientation have a cosine similarity of 1, two vectors oriented at 90π relative to each other have a similarity of 0, and two vectors diametrically opposed have a similarity of −1, independent of their magnitude. As a non-limiting example, vectors may be considered similar if parallel to one another. As a further non-limiting example, vectors may be considered dissimilar if orthogonal to one another. As a further non-limiting example, vectors may be considered uncorrelated if opposite to one another. Additionally, or alternatively, degree of similarity may include any other geometric measure of distance between vectors.

Additionally, or alternatively, and still referring to FIG. 1, validation of identified user archetype 144 may aid in refining behavioral analysis module's 140 accuracy over time. In an embodiment, one or more discrepancies may be located between identified user archetype 144 and pre-defined set of behavioral archetypes 152, and a feedback loop may be established by processor 104 to adjust and fine-tune criteria used for user archetype identification described herein. In a non-limiting example, if user's 116 interactions align closely with both a “novice” and an “expert” user archetype due to a mix of basic and advanced queries, processor 104 may introduce a new “intermediate” user archetype or adjust one or more criteria for existing user archetypes to better capture such users.

With continued reference to FIG. 1, processor 104 is configured to selectively initiate a user event 156 based on validated user archetype 144. As used in this disclosure, a “user event” refers to one or more actions, responses, interactions triggered within system and/or apparatus 100 in response to certain conditions or criteria being met. In some embodiments, user event 156 may include at least one user prompt 160. A “user prompt,” for the purpose of this disclosure, is a specific element or message designed to elicit a particular response or action from the user, based on validated user archetype 144 and/or historical user data including historical user activity data. In some cases, user prompt may include, without limitation, visual user prompt, audio user prompt, and/or the like. In one or more embodiments, user prompt 160 may serve as a direct communication channel, enabled by chatbot 132 as described above, between processor 104 and user 116 and/or plurality of users, guiding, informing, and/or requesting user input from user 116. In some cases, user prompts may include, without limitation, a system notification, content recommendation, system alert, chatbot response, or interactive prompt. For instance, and without limitation, a visual user prompt may include a pop-up window, a highlighted section, a tooltip, or a dynamic content area that changes based on user archetype 144. In a non-limiting example, user 116 with a “novice learner” navigating a tutorial section, frequently pause or revisit certain steps, a pop-up window (i.e., user prompt 160) may appear offering a video demonstration or step-by-step guide for that particular process (i.e., user event 156). Alternatively, for a user archetype identified as an “expert user,” the dynamic content area may adapt to show advanced settings or shortcuts, streamlining their experience. Further, if processor 104 detects a user archetype 144 characterized as a “frequent shopper” on an e-commerce platform in digital environment, a highlighted section may appear showcasing exclusive deals or personalized product recommendations.

In a non-limiting example, and still referring to FIG. 1, in an embodiment related to educational environments, behavioral analysis module 140 may evaluate user activity data 120 to discern certain personality traits or behavioral tendencies of the user (i.e., interaction indicator 136), who in this context may be a student. For instance, and without limitation, if analysis of the student's interactions, responses, and engagement patterns suggests that the student is shy or less vocal (i.e., user archetype 144) in their interactions, processor 104, through chatbot 132, may initiate one or more user events 156 configured to take proactive measures to encourage participation. In some cases, one or more user events 156 may include specific user prompts 160 containing one or more questions directed towards the student based on such inferred trait, nudging student to voice their thoughts or participate more actively in discussions. Selectively initiating user events 156 may ensure that each student, regardless of their inherent disposition, is given an opportunity to engage and contribute, fostering a more inclusive learning environment.

With continued reference to FIG. 1, in some cases, user event 156 and/or user prompt 160 may be transmitted, by processor 104, to one or more display devices 164 communicatively connected to processor 104, for example, and without limitation, user devices having at least one display capable of presenting a graphical user interface (GUI) to end user e.g., user 116. As used in this disclosure, a “display device” refers to an electronic device that visually presents information to the user. In some cases, display device 164 may be configured to project or show visual content generated by computers, video devices, or other electronic mechanisms. In some cases, display devices may include, without limitation, a liquid crystal display (LCD), a cathode ray tube (CRT), a plasma display, a light emitting diode (LED) display, and any combinations thereof. In a non-limiting example, one or more display devices 164 may vary in size, resolution, technology, and functionality. Display device 164 may be able to show any data and/or visual elements described herein in various format such as, textural, graphical, video among others, in either monochrome or color.

Still referring to FIG. 1, a “graphical user interface (GUI),” as used herein, is a graphical form of user interface that allows user 116 to interact with apparatus 100. In some embodiments, GUI may include icons, menus, other visual indicators, or representations (graphics), audio indicators such as primary notation, and display information and related user controls. In one or more embodiments, GUI may serve as a primary medium through which one or more user events 156 and/or user prompts 160 are presented to user 116. In some cases, user event 156 may also include a change in GUI, such as, without limitation, presentation of a new module, adjustment of content display, initiation of a feedback loop, and/or the like. For instance, and without limitation, when user event 156 is triggered, GUI may dynamically change to display the corresponding user prompt 160. In a non-limiting example, if validated user archetype 144 suggests that user 116 prefers visual aids, GUI may be configured, by processor 104, to present user prompt in the form of an animated tutorial. Conversely, if user archetype 144 indicates a preference for textual information, processor 104 may initiate user event 156 including configuring the GUI to display a detailed text box or a tooltip. Further, GUI may be designed to capture feedback from user 116 regarding the relevance and effectiveness of user prompts 160, allowing processor 104 to continuously refine one or more processing steps described herein. In a non-limiting example, if a user frequently dismisses a certain type of prompt, GUI of display device 164 may adapt to present alternative forms of prompts or reduce the frequency of that specific prompt.

With continued reference to FIG. 1, decision to initiate user event 156 may not be solely based on user archetype 144, but also may take into account cue datum 124. In an embodiment, user event 156 may be selected, by processor 104, from a plurality of pre-determined user events based on cue datum 124. Cue datum 124 may provide real-time or near-real-time insights into the user's current behavior or interaction with the system. In a non-limiting example, processor 104 may employ one or more machine learning algorithms described herein to weigh the importance of cue datum 124 against identified user archetype 144 to determine one or more most appropriate user events to initiate. For instance, and without limitation, processor 104 may receive a cue datum indicates a sudden increase in user interaction frequency, a user archetype corresponds to a “highly-engaged user” may be identified, and processor 104 may initiate a user event that offers advanced content or challenges. Conversely, if cue datum 124 suggests a decrease in interaction and identified user archetype is “occasional user”, processor 104 may trigger a user event that offers assistance, tutorials, or reminders.

With continued reference to FIG. 1, other exemplary embodiments of user event 156 may include an automated system action that doesn't necessarily involve direct interaction with user 116. In a non-limiting example, based on the validated user archetype 144, apparatus 100 may automatically adjust settings or configurations of the system and/or components thereof. If user archetype suggests that the current user is a “first-time user”, the system might automatically enable a user-friendly mode, simplifying system's features and functionalities (e.g., settings of chatbot 132) without any explicit user prompts 160. In yet another embodiment, user event 156 may involve data collection or logging process. In a non-limiting example, if processor 104 detects a pattern of frequent errors or challenges faced by user 116, processor 104 may automatically log these incidents as events. These logged events may then be used for further processing steps as described in detail below, for example, and without limitation, updating one or more machine learning models and their corresponding training data described herein.

Still referring to FIG. 1, in a further embodiment, user event 156 may include a trigger for one or more background processes. In a non-limiting example, if behavioral analysis module 140 detects that a user often accesses a particular set of data or tools during specific times of the day, processor 104 may preemptively load or cache corresponding resources right before the user typically accesses them. Additionally, or alternatively, user event 156 may involve one or more external integrations in case of apparatus 100 being a part of a larger ecosystem of devices or platforms networks, certain user archetype 144 or cue datum may trigger user events 156 on one or more external systems. For example, and without limitation, if a user frequently pairs activities on apparatus 100 with another device, such as a smart home system, such interaction indicator 136 determined by behavioral analysis module 140 may trigger one or more synchronized actions on both platforms, establishing a cross-device communication.

With continued reference to FIG. 1, in one or more embodiments, selectively initiating user event 156 may include generating a plurality of user events using an event generation model 168 using machine learning module as described above. Event generation model 168 may be trained using user event training data, wherein the user event training data may include a plurality of behavioral archetypes as input correlated to a plurality of user events as output. In some cases, generating plurality of user events may further include generating, using event generation model 168, a plurality of user prompts, wherein each user prompt of the plurality of user prompts may correspond to one or more user events of plurality of user events. In a non-limiting example, for an interaction indicator aligns with a user archetype of a “curious learner,” processor 104 may generated, using trained event generation model 168, a plurality of events containing a plurality of user prompts based on such user archetype, suggesting advanced reading materials or challenging quizzes, thereby catering to user's 116 inherent curiosity and thirst for knowledge. Processor 104 may then be configured to select at least one user event from plurality of user events generated by event generation model 168 and initiate the at least one user event selected.

With continued reference to FIG. 1, in one or more embodiments, processor 104 may implement one or more aspects of “generative artificial intelligence (AI),” a type of AI that uses machine learning algorithms to create, establish, or otherwise generate data such as, without limitation, user event 156, user prompt 160, and/or the like in any data structure as described herein (e.g., text, image, video, audio, among others) that is similar to one or more provided training examples. In an embodiment, machine learning module described herein may generate one or more generative machine learning models that are trained on one or more set of example user events and/or example user prompts. In some cases, example user events and/or example user prompts may historical user events and/or user prompts, for example, and without limitation, user interactions from previous sessions, feedback loops from prior user event, conversation history, and/or the like. One or more generative machine learning models may be configured to generate new examples that are similar to the training data of the one or more generative machine learning models but are not exact replicas; for instance, and without limitation, data quality or attributes of the generated examples may bear a resemblance to the training data provided to one or more generative machine learning models, wherein the resemblance may pertain to underlying patterns, features, or structures found within the provided training data.

Still referring to FIG. 1, in some cases, generative machine learning models may include one or more generative models. As described herein, “generative models” refers to statistical models of the joint probability distribution P(X, Y) on a given observable variable x, representing features or data that can be directly measured or observed (e.g., interaction indicator 136, user archetype 144, and/or the like) and target variable y, representing the outcomes or labels that one or more generative models aims to predict or generate (e.g., user event 156, user prompt 160, and/or the like) In some cases, generative models may rely on Bayes theorem to find joint probability; for instance, and without limitation, Naïve Bayes classifiers may be employed by processor 104 to categorize input data such as, without limitation, user archetype 144 into different sub-categories or sub-classes such as, without limitation, “active users,” “passive users,” “frequent users,” or “occasional users.”

In a non-limiting example, and still referring to FIG. 1, one or more generative machine learning models may include one or more Naïve Bayes classifiers generated, by processor 104, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)−P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction.

Still referring to FIG. 2, although Naïve Bayes classifier may be primarily known as a probabilistic classification algorithm; however, it may also be considered a generative model described herein due to its capability of modeling the joint probability distribution P(X, Y) over observable variables X and target variable Y. In an embodiment, Naïve Bayes classifier may be configured to make an assumption that the features X are conditionally independent given class label Y, allowing generative model to estimate the joint distribution as P(X, Y)=P(Y)ΠiP(Xi|Y), wherein P(Y) may be the prior probability of the class, and P(Xᵢ|Y) is the conditional probability of each feature given the class. One or more generative machine learning models containing Naïve Bayes classifiers may be trained on labeled training data, estimating conditional probabilities P(Xᵢ|Y) and prior probabilities P(Y) for each class; for instance, and without limitation, using techniques such as Maximum Likelihood Estimation (MLE). One or more generative machine learning models containing Naïve Bayes classifiers may select a class label y according to prior distribution P(Y), and for each feature Xᵢ, sample at least a value according to conditional distribution P(Xᵢ|y). Sampled feature values may then be combined to form one or more new data instance with selected class label y. In a non-limiting example, one or more generative machine learning models may include one or more Naïve Bayes classifiers to generate new examples of user event and/or user prompt based on classified interaction indicators (e.g., user archetypes and/or sub-categories of user archetypes described above), wherein the models may be trained using training data containing a plurality of features of user archetypes e.g., behavioral traits, engagement levels, or specific behavioral patterns, and/or the like as input correlated to a plurality of user events e.g., user prompts, system notifications, content recommendations, interactive questions, and/or the like as output.

Still referring to FIG. 1, in some cases, one or more generative machine learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model as described in further detail with reference to FIG. 2.

With continued reference to FIG. 1, in an embodiment, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 2 to distinguish between different categories e.g., real vs. fake, or states e.g., TRUE vs. FALSE within the context of generated data such as, without limitations, plurality of user events, user prompts, and/or the like. In some cases, processor 104 may implement one or more classification algorithms such as, without limitation, Support Vector Machines (SVM), Logistic Regression, Decision Trees, and/or the like to define decision boundaries.

In a non-limiting example, and still referring to FIG. 1, generator of GAN may be responsible for creating synthetic data that resembles real user events and/or user prompts. In some cases, GAN may be configured to receive a plurality of interaction indicators and corresponding user archetypes, as input and generates corresponding user events and/or user prompts containing information describing or evaluating the performance of one or more interaction indicated by the plurality of interaction indicators based on corresponding user archetypes. On the other hand, discriminator of GAN may evaluate the authenticity of the generated content by comparing it to real user events and/or user prompts, for example, discriminator may distinguish between genuine and generated content and providing feedback to generator to improve the model performance.

With continued reference to FIG. 1, in other embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

In a non-limiting example, and still referring to FIG. 1, VAE may be used by processor 104 to model complex relationships between interaction indicators or user archetypes and user events including user prompts. For instance, and without limitation, VAE may be trained to generate one or more user events or prompts that are most likely to engage specific user archetypes based on their past behaviors and interaction indicators. In some cases, VAE may encode input data into a latent space, capturing features or characteristics that define user's behavior or archetype. Such encoding process may include learning one or more probabilistic mappings from observed interaction indicators and/or user archetypes to a lower-dimensional latent representation. Latent representation may then be decoded back into the original data space, therefore reconstructing one or more projected user action (e.g., potential user response) as described above to different types of user events or prompts. In some cases, such decoding process may allow VAE to generate new examples or variations that are consistent with the learned distributions.

With continued reference to FIG. 1, in some embodiments, one or more generative machine learning models may be trained on a plurality of user data 112 in either audio or visual format as described above (e.g., voice recordings, video recordings, user images, and/or the like) wherein the plurality user data 112 may provide visual/acoustical information that generative machine learning models analyze to understand the dynamics of user interaction, emotional state, engagement levels, and/or the like. In other embodiments, training data may also include voice-over user prompts; for instance, and without limitation, voice-over prompts that guide user 116 through class registration, course materials, or even provide real-time feedback during a class session. In some cases, such data may help generative machine learning models to learn appropriate language and tone for providing user events containing user prompts. Additionally, or alternatively, one or more generative machine learning models may utilize one or more predefined templates representing, for example, and without limitation, correct user events and/or user prompts. In a non-limiting example, one or more user events and/or user prompt template may serve as benchmarks for comparing and evaluating plurality of generated user events and/or user prompts.

With continued reference to FIG. 1, other exemplary embodiments of generative machine learning models may include, without limitation, long short-term memory networks (LSTMs), (generative pre-trained) transformer (GPT) models, mixture density networks (MDN), and/or the like. As an ordinary person skilled in the art, upon reviewing the entirety of this disclosure, will be aware of various generative machine learning models that may be used to generate user event 156 and/or user prompts 160 as described herein.

Still referring to FIG. 1, in a further non-limiting embodiment, machine learning module may be further configured to generate a multi-model neural network that combines various neural network architectures described herein. In a non-limiting example, multi-model neural network may combine LSTM for time-series analysis with GPT models for natural language processing. Such fusion may be applied by processor 104 to generate user events and/or user prompts. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others. As an ordinary person skilled in the art, upon reviewing the entirety of this disclosure, will be aware of various multi-model neural networks and combination thereof that may be implemented by apparatus 100 in consistent with this disclosure.

With continued reference to FIG. 1, in one or more embodiments, selectively initiating user event 156 may include generating a decision tree 172 as a function of plurality of user events generated by event generation model 168 as described above. As used in this disclosure, a “decision tree” is a data structure that represents and combines one or more determinations or other computations based on and/or concerning data provided thereto, as well as earlier such determinations or calculations, as nodes of a tree data structure where inputs of some nodes are connected to outputs of others. As used in this disclosure, a “node” of a tree is an entity which contains a value or data and optionally contains one or more connections to other nodes. Plurality of nodes within decision tree 172 may include at least a root node, or node that receives data input to the decision tree 172. Plurality of nodes within decision tree 172 may include at least a terminal node, which may alternatively or additionally be referred to herein as a “leaf node,” corresponding to an execution result of decision tree 172. In other words, decisions and/or determinations produced by decision tree 172 may be output at the at least a terminal node. In some embodiments, plurality of nodes within decision tree 172 may include one or more internal nodes, defined as nodes connecting outputs of at least a root node to inputs of at least a terminal node.

With continued reference to FIG. 1, generating decision tree 172 as a function of a plurality of user events may include mapping one or more user events from the plurality of user events to each node within the plurality of nodes that make up decision tree 172. In some cases, mapping user events to nodes may involve associating interaction indicator 136 and/or identified user archetype 144 with each node of plurality of nodes. Processor 104, in this case, may create one or more data pathways of logical decisions that lead to plurality of user events generated by one or more generative machine learning models described above. In one embodiment, mapping process may utilize one or more scoring algorithms that assign weights to each user event based on its relevance or importance in the context of the user data 112. In some cases, weights such as, without limitation, user event relevance score may be determined through one or more machine learning models or set manually by system administrators such as, without limitation, instructors, parents, advisors, and/or the like. Decision tree 172 may then use these weighted user events to prioritize data pathways, effectively guiding the system's interactions with user 116.

Still referring to FIG. 1, In another embodiment, decision tree 172 may be dynamically updated in real-time based on incoming (i.e., new) user data 112, allowing processor 104 to adapt to changing user behaviors or preferences, making decision tree 172 a “living model” that evolves with user 116. In a non-limiting example, at least a root node of decision tree 172 may include a first user event or plurality of user events and at least a terminal node may include a second user event of plurality of user events, wherein the first user event may be a “pre-requisite” of the second user event. A “pre-requisite,” for the purpose of this disclosure, refers to a condition or set of conditions that must be satisfied before subsequent event may be triggered or executed. Initiation of second user event may be based on an execution of first user event. For instance, without limitation, first user event may be a user login, and second user event may be a personalized content recommendation, wherein the personalized content recommendation would only be triggered if user 116 successfully log in. As another example, and without limitation, first user event may be a completion of a tutorial or onboarding process, and second user event may be unlocking advanced features or levels within an application, wherein the completion of the tutorial serves as a pre-requisite for accessing the advanced features.

Still referring to FIG. 1, in some cases, processor 104 may generate two or more decision trees 172, which may overlap. In a non-limiting example, a root node of one decision tree may connect to and/or receive output from one or more terminal nodes of another decision tree, allowing for a dynamic and interconnected decision-making process in user events selection and/or initiation. In some cases, output of one decision tree may influence a starting point of another. Additionally, plurality of intermediate nodes of one decision tree may be shared with another decision tree, thereby creating a network of decision trees that may operate in a more integrated fashion. In a non-limiting example, a terminal node of a first decision tree focused on user onboarding may trigger a personalized content recommendation, where the terminal node may also be the root node for a second decision tree focused on user retention. Such interconnected decision tree approach may enable a seamless transition between different stages of user interaction as described herein.

With continued reference to FIG. 1, selectively initiating user event 156 may include traversing generated decision tree 172 as a function of interaction indicator 136 and selectively initiate at least user event of plurality of user events based on the decision tree traversal. In some cases, traversing decision tree 172 may include evaluating one or more conditional statements at each node, which may be formulated based on interaction indicators 136 such as particular user behavior pattern, frequency of interactions, or types of actions taken. In other cases, decision tree traversal may be influenced by real-time data such as, without limitation, user response as described below, allowing processor 104 to make dynamic user event selection and/or initiation that adapt to user's 116 current state or actions; for instance, and without limitation, decision tree 172 may be adjust to prioritize user events that capitalize on heightened user engagement when decision tree 172 detects a sudden increase in user interaction frequency (i.e., interaction indicator 136).

Still referring to FIG. 1, in an embodiment, decision tree 172 may be traversed using a depth-first or breadth-first search algorithm, depending on specification of the system or user preferences. A depth-first search algorithm may prioritize exploring as far down a branch (of nodes) as possible before backtracking, while breadth-first search algorithm may explore all neighbor nodes at present depth before moving on to nodes at next depth level. In some cases, choice of traversal algorithm may impact the speed and efficiency of initiating appropriate user events 156. In a non-limiting example, a depth-first search may quickly provide a highly personalized user event but may miss out on other relevant user events that could be discovered through a breadth-first search. Conversely, a breadth-first search may offer a more balanced set of user events but may be slower in reaching highly personalized user events.

With continued reference to FIG. 1, processor 104 is configured to iteratively listen for a user response 176 to user event 156. As described herein, “iteratively listen,” refers to the continuous or periodic monitoring of user interactions with apparatus 100, capturing any form of feedback, actions, or inactions that may serve as “user response” to the initiated user event. In some cases, user response may include, without limitation, clicks, voice commands, text inputs, any user activities/actions described above, or even lack of interaction with a specific time frame. User response to initiated user event may vary widely, for instance, and without limitation, in a text-based interface, such as GUI displaying chatbot 132 as described herein, user 116 may respond by typing questions or answers to questions or selecting one or multiple-choice options presented as part of user event. In voice-activated system, however, user 116 may respond verbally, and this verbal feedback may be captured, by microphone and processed, via automatic speech recognition in real-time. Additionally, or alternatively, in a more passive system, user's 116 mere dwell time on a particular piece of content may be detected and considered a form of response.

Still referring to FIG. 1, user response 176 is configured to alert a subsequent interaction indicator 180 upon a re-evaluation of user activity data 120 using the behavioral analysis module 140. As used in this disclosure, a “subsequent interaction indicator” refers to a refined or updated set of metrics, variables, or features that characterize user's 116 behavior or interaction with the apparatus 100 after user event 156 has been initiated and user response 176 has been received. Subsequent interaction indicator 180 may include, without limitation, updates of any interaction indicator 136 as described above such as frequency of interactions, duration of sessions, types of actions taken, and/or the like. In some cases, subsequent interaction indicator 180 may even include new forms of user engagement that were not previously captured. In some embodiments, subsequent interaction indicator 180 may server as an evolved form of (initial) interaction indicator 136 as described above, incorporating newly acquired data from the user's 116 most recent interactions e.g., submission of user response 176. In a non-limiting example, if initial interaction indicator included metrics like average session duration and click-through rate, subsequent interaction indicator may additionally incorporate new metrics such as “time spent on recommended content” or “frequency of voice commands used,” based on the user's recent behavior besides metrics in initial interaction indicator. In some cases, subsequent interaction indicator 180 may be fed back into the behavioral analysis module 140 for further analysis and to inform the generation of a second set of user events that are even more targeted and relevant to user 116.

Still referring to FIG. 1, in an embodiment, iteratively listen for user response 176 to user event 156 may include receive subsequent user activity data 184 pertaining to user 116 and scoring the subsequent user activity data 184 as a function of user activity data 120 using the behavioral analysis module 140. As used in this disclosure, “subsequent user activity data” refers to any data points describing user's 116 actions, behaviors, or interactions collected after the initiation of user event 156. Subsequent user activity data 184 may include any user activity data as described above. In some cases, subsequent user activity data may include, without limitation, time spent on a task, click-through rates, completion rates of specific actions, or even qualitative data such as user input like feedback or comment. Subsequent user activity data 184 may be collected through various means as described herein, including but not limited to, tracking pixels, cookies, event listeners, and/or the like. In an embodiment, behavioral analysis module 140 may generate a composite score as described above for each data entry within subsequent user activity data 184. One or more machine learning models or statistical models described herein may be configured to generate such score by weighing the importance of various metrics based on their relevance to user archetype 144 and specific user event 156. In a non-limiting example, for a user event involving content recommendation, subsequent user activity data 184 collected by processor 104 may show that user 116 not only clicked on the recommended content, but also spent a significant amount of time engaging with it. Behavioral analysis module 140 may score this user action as a highly positive user response. Such high score may influence user events generation, selection, and/or initiation in future iterations.

Still referring to FIG. 1, in another embodiment, subsequent interaction indicator 180 may trigger a re-assessment of user archetype 144. In some cases, processor 104 may be configured to potentially re-categorize user 116 based on user response 176 and corresponding subsequent interaction indicator 180. In a non-limiting example, user archetype classifier 148 may be configured to analyze the new set of interaction indicators (e.g., subsequent interaction indicators 180) and generate an updated user archetype accordingly. In some cases, during the re-classification or re-categorization of user archetype 144, certain features may be re-weighted based and new features may be added based on user response 176. For instance, and without limitation, if user 116 initially was categorized as a “passive consumer” based on their low interaction rates but has recently started to engage more actively with the content, user archetype classifier 148 may update user's 116 user archetype to an “active consumer” or even a “power user,” depending on the specific metrics captured in subsequent interaction indicator 180. In some cases, updated user archetype may then be used to traverse decision tree 172 anew, leading to potentially different paths and user events that are more aligned with the user's current behavior.

With continued reference to FIG. 1, behavior analysis module may include one or more generative machine learning models described herein to analyze input data such as, without limitation, subsequent interaction indicators 180 to one or more predefined user prompt templates such as “Welcome” messages, “Error” messages, “User Guidance” messages, and/or the like, representing subsequent user events. In some cases, processor 104 may be configured to pinpoint specific errors in user response 176. In a non-limiting example, processor 104 may be configured to implement generative machine learning models to incorporate additional models to detect fraudulent activities or anomalies in user response 176. In some cases, errors may be classified into different categories or severity levels. In a non-limiting example, some errors may be considered minor, and generative machine learning model such as, without limitation, GAN may be configured to generate user prompts that contain only slight adjustments while others may be more significant and demand more substantial corrections. In some embodiments, processor 104 may be configured to flag or highlight errors in user response 176, prompting user 116 for correction, directly on display device 164 as described above using one or more generative machine learning models. In some cases, one or more generative machine learning models may be configured to generate and output user prompts containing indicators such as, without limitation, visual indicator, audio indicator, and/or any other indicators as described above. Such indicators may be used to signal the detected error described herein.

Still referring to FIG. 1, in some cases, processor 104 may be configured to identify and rank detected common deficiencies (e.g., low engagement, incomplete tasks, frequent errors) across plurality of user responses; for instance, and without limitation, one or more machine learning models may classify errors in a specific order e.g., frequency or severity as described above in a descending or ascending order. Such ranking process may enable a prioritization of most prevalent issues, allowing instructors, system administrators, or processor 104 itself to address the listed deficiencies in a targeted manner. In a non-limiting example, processor 104 may detect that a large percentage of users are filling to complete a specific task within a user event under a group session setting and trigger a re-evaluation of user event or user prompt, potentially leading to one or more modifications (e.g., simplifying the task, providing additional resources or hints that suit identified user archetype 144, and/or the like) configured to improve user engagement and task completion rates.

Still referring to FIG. 1, in some cases, one or more generative machine learning models may also be applied by processor 104 to edit, modify, or otherwise manipulate existing data or data structures. In an embodiment, output of training data used to train one or more generative machine learning models such as GAN as described herein may include synthetic user response modifications that linguistically or visually demonstrate modified user response 176 e.g., paraphrased text or altered facial expressions, and/or the like. In some cases, synthetic user response modifications may be synchronized with user response 176, for example, and without limitation, if user response 176 is a text-based answer to a question, generative machine learning models may produce alternative phrasings of the same answer, which may then be analyzed for sentiment of intent as subsequent interaction indicator 180 as described above. Additionally, or alternatively, such synthetic user response modifications may be integrated with original dataset e.g., user data 112 and/or user activity data to improve the performance and accuracy of subsequent outputs and/or machine learning models as described herein.

Additionally, or alternatively, and still referring to FIG. 1, processor 104 may configure discriminators of one or more generative machine learning models to provide ongoing feedback and further corrections as needed to subsequent input data (e.g., subsequent user response received by processor 104 in future iterations). An iterative feedback loop may be created as processor 104 continuously receive real-time data, identify errors as a function of real-time data, delivering corrections based on the identified errors, and monitoring subsequent user response on the delivered corrections. In an embodiment, processor 104 may be configured to retrain one or more generative machine learning models based on user response 176 and/or subsequent user responses or update training data of one or more generative machine learning models by integrating subsequent user responses into the original training data. In such embodiment, iterative feedback loop may allow machine learning module to adapt to the evolving behavioral patterns and preferences of user 116, enabling one or more generative machine learning models described herein to learn and update based on user response 176 and generated feedback.

Referring now to FIG. 2, an exemplary embodiment of a machine-learning module 200 that may perform one or more machine-learning processes as described in this disclosure is illustrated. Machine-learning module 200 may perform determinations, classification, and/or analysis steps, methods, processes, or the like as described in this disclosure using machine-learning processes. A “machine-learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine-learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, a set of architecture profile characteristics may be used as inputs wherein training data from historical engagements supports affiliating some, all, or none of the architecture profile attributes with certain classifier descriptors. In a specific non-limiting embodiment, an architecture profile may include an asphalt driveway project, which may apply a classifier descriptor of “asphalt” and “driveway” based not only on those words appearing, but on historical engagements showing that those descriptors are productive and accurate.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine-learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to a certain type of project or engagement, wherein the sub-population of certain projects or engagements require a unique user archetype.

With further reference to FIG. 2, training examples for use as training data may be selected from a population of potential examples according to cohorts relevant to an analytical problem to be solved, a classification task, or the like. Alternatively, or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively, or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving or retrieving a missing input and/or output value and correlating the missing input and/or output value with a corresponding output and/or input value collocated in a data record with the retrieved value, provided by a user and/or another device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively, or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine-learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by up-sampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs down-sampled to smaller numbers of units, and a neural network or other machine-learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been down-sampled to smaller numbers of pixels, and a neural network or other machine-learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively, or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform down-sampling on data. Down-sampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to cleanup side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine-learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively, or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include labeled seed data, as described above as inputs, vector clustering, as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively, or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine-learning processes may include at least an unsupervised machine-learning processes 232. An unsupervised machine-learning process, as used herein, is a process that derives inferences in data sets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above. Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

Referring to FIG. 3, a chatbot system 300 is schematically illustrated. According to some embodiments, a user interface 304 may be communicative with a computing device 308 that is configured to operate a chatbot. In some cases, user interface 304 may be local to computing device 308. Alternatively, or additionally, in some cases, user interface 304 may remote to computing device 308 and communicative with the computing device 308, by way of one or more networks, such as without limitation the internet. Alternatively, or additionally, user interface 304 may communicate with user device 308 using telephonic devices and networks, such as without limitation fax machines, short message service (SMS), or multimedia message service (MMS). Commonly, user interface 304 communicates with computing device 308 using text-based communication, for example without limitation using a character encoding protocol, such as American Standard for Information Interchange (ASCII). Typically, a user interface 304 conversationally interfaces a chatbot, by way of at least a submission 312, from the user interface 308 to the chatbot, and a response 316, from the chatbot to the user interface 304. In many cases, one or both submission 312 and response 316 are text-based communication. Alternatively, or additionally, in some cases, one or both of submission 312 and response 316 are audio-based communication.

Continuing in reference to FIG. 3, a submission 312 once received by computing device 308 operating a chatbot, may be processed by a processor. In some embodiments, processor processes submission 312 using one or more keyword recognition, pattern matching, and natural language processing. In some embodiments, processor employs real-time learning with evolutionary algorithms. In some cases, processor may retrieve a pre-prepared response from at least a storage component 320, based upon submission 312. Alternatively, or additionally, in some embodiments, processor communicates a response 316 without first receiving a submission 312, thereby initiating conversation. In some cases, processor communicates an inquiry to user interface 304; and the processor is configured to process an answer to the inquiry in a following submission 312 from the user interface 304. In some cases, an answer to an inquiry presents within a submission 312 from a user device 304 may be used by computing device 308 as an input to another function.

Now referring to FIG. 3, in some embodiments, apparatus 100 may communicate with user and/or instructor using a chatbot. According to some embodiments, one or more user interfaces including first user interface 304a and second user interface 304b on one or more user devices including first user device 332a and second user device 332b may be communicative with a computing device 308 that is configured to operate a chatbot. In some embodiments, one or more user devices may be communicative in this way, such as 1, 2, 3, 4, 5, 6, 7, 8, 9, 10, 20, 30, 40, 50, 60, 70, 80, 90, 100, or more user devices. In some embodiments, first user interface 304a may be local to first user device 332a. In some embodiments, additional user interfaces such as second user interface 304b may be local to their respective user devices. In some embodiments, first user interface 304a may be local to computing device 308. In some embodiments, additional user interfaces such as second user interface 304b may be local to computing device 308. Alternatively or additionally, in some cases, first user interface 304a may remote to first user device 332a and communicative with first user device 332a, by way of one or more networks, such as without limitation the internet. Alternatively or additionally, one or more user interfaces may communicate with computing device 308 using telephonic devices and networks, such as without limitation fax machines, short message service (SMS), or multimedia message service (MMS). Commonly, user interfaces such as first user interface 304a communicate with computing device 308 using text-based communication, for example without limitation using a character encoding protocol, such as American Standard for Information Interchange (ASCII). Typically, user interfaces conversationally interface with a chatbot, by way of at least a submission, from a user interface to the chatbot, and a response, from the chatbot to the user interface. For example, first user interface 304a may interface with a chatbot using first submission 312a and first response 316a. In another example, second user interface 304b may interface with a chatbot using second submission 312b and second response 316b. In some embodiments, submissions such as first submission 312a and/or responses such as first response 316a may use text-based communication. In some embodiments, submissions such as first submission 312a and/or responses such as first response 316a may use audio communication.

Still referring to FIG. 3, a submission such as first submission 312a once received by computing device 308 operating a chatbot, may be processed by a processor 320. In some embodiments, processor 320 processes a submission such as first submission 312a using one or more of keyword recognition, pattern matching, and natural language processing. In some embodiments, processor employs real-time learning with evolutionary algorithms. In some cases, processor 320 may retrieve a pre-prepared response from at least a storage component 324, based upon submission such as first submission 312a. Alternatively or additionally, in some embodiments, processor 320 communicates a response such as first response 316a without first receiving a submission, thereby initiating conversation. In some cases, processor 320 communicates an inquiry to a user interface such as first user interface 304a; and processor 320 is configured to process an answer to the inquiry in a following submission from the user interface. In some cases, an answer to an inquiry present within a submission from a user device may be used by computing device 308 as an input to another function. In some embodiments, computing device 308 may include machine learning module 328. Machine learning module 328 may include any machine learning models described herein. In some embodiments, a submission such as first submission 312a may be input into a trained machine learning model within machine learning module 328. In some embodiments, a submission such as first submission 312a may undergo one or more processing steps before being input into a machine learning model. In some embodiments, a submission such as first submission 312a may be used to train a machine learning model within machine learning module 328.

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. In a non-limiting embodiment, input layer of nodes 404 may include any remote display where user inputs may be provided from, while output layer of nodes 412 may include either the local device if it has the processing capability to support the requisite machine-learning processes, or output layer of nodes 412 may refer to a centralized, network connected processor able to remotely conduct the machine-learning processes described herein. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

With continued reference to FIG. 4, in an embodiment, neural network may include a deep neural network (DNN). As used in this disclosure, a “deep neural network” is defined as a neural network with two or more hidden layers. In a non-limiting example, neural network may include a convolutional neural network (CNN). A “convolutional neural network,” for the purpose of this disclosure, is a neural network in which at least one hidden layer is a convolutional layer that convolves inputs to that layer with a subset of inputs known as a “kernel,” along with one or more additional layers such as pooling layers, fully connected layers, and the like. In some cases, CNN may include, without limitation, a deep neural network (DNN) extension. Mathematical (or convolution) operations performed in the convolutional layer may include convolution of two or more functions, where the kernel may be applied to input data e.g., user activity data through a sliding window approach. In some cases, convolution operations may enable processor 104 to detect local/global patterns, edges, textures, and any other features described herein within input data. Features within input data may be passed through one or more activation functions, such as without limitation, Rectified Linear Unit (ReLU), to introduce non-linearities into one or more generating processing steps as described above with reference to FIGS. 1-3. Additionally, or alternatively, CNN may also include one or more pooling layers, wherein each pooling layer is configured to reduce the dimensionality of input data while preserving essential features within the input data. In a non-limiting example, CNN may include one or more pooling layer configured to reduce the dimensions of feature maps by applying downsampling, such as max-pooling or average pooling, to small, non-overlapping regions of one or more features.

Still referring to FIG. 4, CNN may further include one or more fully connected layers configured to combine features extracted by the convolutional and pooling layers as described above. In some cases, one or more fully connected layers may allow for higher-level pattern recognition. In a non-limiting example, one or more fully connected layers may connect every neuron (i.e., node) in its input to every neuron in its output, functioning as a traditional feedforward neural network layer. In some cases, one or more fully connected layers may be used at the end of CNN to perform high-level reasoning and produce the final output such as, without limitation, interaction indicator and/or user archetype. Further, each fully connected layer may be followed by one or more dropout layers configured to prevent overfitting, and one or more normalization layers to stabilize the learning process described herein.

With continued reference to FIG. 4, in an embodiment, training the neural network (i.e., CNN) may include selecting a suitable loss function to guide the training process. In a non-limiting example, a loss function that measures the difference between the predicted output and the ground truth (e.g., a pre-defined set of behavioral archetypes) may be used, such as, without limitation, mean squared error (MSE) or a custom loss function may be designed for one or more embodiments described herein. Additionally, or alternatively, optimization algorithms, such as stochastic gradient descent (SGD), may then be used to adjust CNN's parameters to minimize such loss. In a further non-limiting embodiment, instead of directly predicting classification or category of input data, CNN may be trained as a regression model to predict numerical output such as numerical interaction indicator as described above with reference to FIG. 1. Additionally, CNN may be extended with additional deep learning techniques, such as recurrent neural networks (RNNs) or attention mechanism, to capture additional features and/or data relationships within input data.

Referring now to FIG. 5, an exemplary embodiment of a node 500 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as ƒ(x)=tan h²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a(1+tan h (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

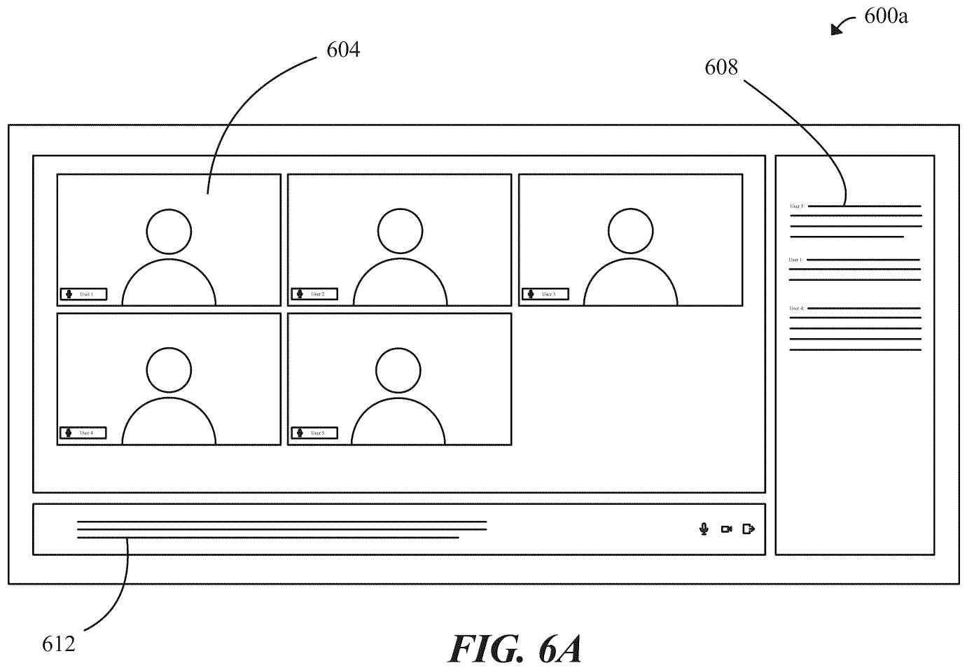

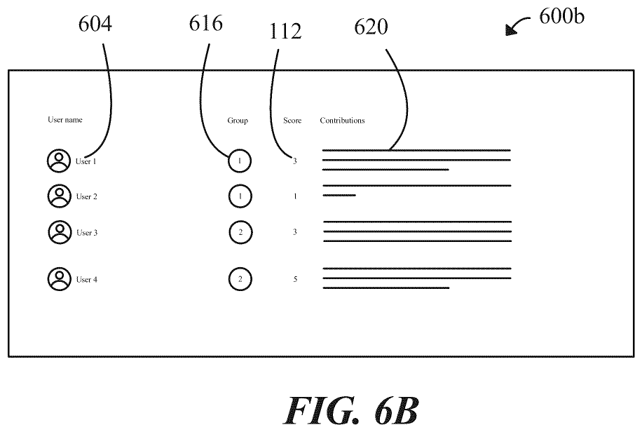

Now referring to FIG. 6A, an exemplary interface 600a is depicted. In some embodiments, apparatus 100 and/or an associated device such as display device 164 may display interface 600a. Interface 600a may be used, for example, on user device as described above during a discussion session. Interface 600a may include representations of one or more users 604, such as video feeds of those users. Interface 600a may include chat window 608 into which users may input messages (i.e., user responses). In some embodiments, chat window 608 may include one or more additional tabs containing additional resources or configured to initiate user events. For example, formulas useful for solving a problem posed by a prompt may be presented in such additional resources. In some embodiments, interface 600 may include prompt field 612 which may display a user prompt generated as described herein. As described above, user prompts may change during a user event e.g., discussion session, such as in order to generate additional data on a user that has not spoken yet. Such a change may be reflected in prompt field 612.

Now referring to FIG. 6B, an exemplary interface 600b is depicted. In some embodiments, apparatus 100 and/or an associated device such as display device 164 may display interface 600b. Interface 600b may be used, for example, on a user device while instructor is viewing user responses 176. Interface 600b may include a field identifying one or more users 604. Interface 600b may include a field identifying which group the one or more users are in 616. Interface 600b may include a field indicating user data 112 e.g., a graded score. Interface 600b may include a field including contributions users made to a discussion 620. In some embodiments, certain contributions may be highlighted or otherwise emphasized as described above.

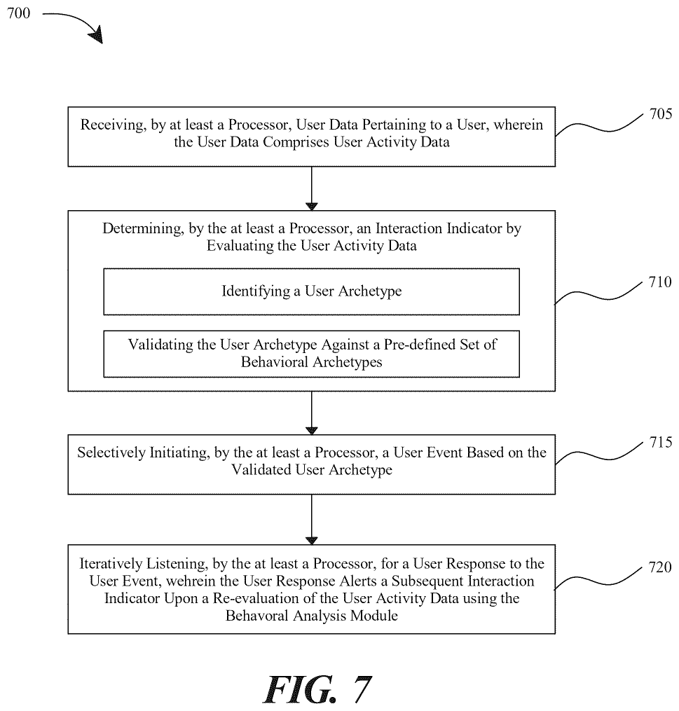

Referring now to FIG. 7, a flow diagram of an exemplary method 700 for assisted learning is illustrated. The method 700 includes a step 705 of receiving, by at least a processor, user data pertaining to a user, wherein the user data comprises user activity data. In some embodiments, the user activity data may include at least one cue datum. In some embodiments, receiving the user data may include receiving the user data using a chatbot. This may be implemented, without limitation, as described above with reference to FIGS. 1-6.

With continued reference to FIG. 7, method 700 includes a step 710 of determining, by the at least a processor, an interaction indicator by evaluating the user activity data using a behavioral analysis module, wherein determining the interaction indictor includes identifying a user archetype based on user activity data and validate the user archetype against a pre-defined set of behavioral archetypes. In some embodiments, identifying the user archetype may include training a user archetype classifier using user archetype training data, wherein the user archetype training data may include a plurality of user activity data as input correlated to a plurality of user archetypes as output and classifying the user activity data into the user archetype using the trained user archetype classifier. In some embodiments, validating the user archetype may include calculating a similarity metric between the user activity data and each behavioral archetype within the pre-defined set of behavioral archetypes and comparing the similarity metric against a pre-determined threshold. This may be implemented, without limitation, as described above with reference to FIGS. 1-6.

With continued reference to FIG. 7, method 700 includes a step 715 of selectively initiating, by the at least a processor, a user event based on the validated user archetype. In some embodiments, the user event may include at least one user prompt. In some embodiments, selectively initiating the user event may include generating a plurality of user events using an event generation model trained using user event training data, wherein the user event training data may include a plurality of behavioral archetypes as input correlated to a plurality of user events as output and selecting at least one user event from the plurality of user events based on the validated user archetype. In some embodiments, selectively initiating the user event further may further include generating a decision tree as a function of the plurality of user events, wherein the decision tree may include a plurality of nodes containing at least a root node and at least a terminal node connected to the at least a root node, wherein the at least a root node contains a first user event of the plurality of user events and the at least a terminal node contains a second user event of the plurality of user events, wherein the first user event is a pre-requisite of the second user event. In some embodiments, selectively initiating the user event may further include traversing the generated decision tree as a function of the interaction indicator and selectively initiating the user event based on the decision tree traversal. This may be implemented, without limitations, as described above with reference to FIGS. 1-6.

With continued reference to FIG. 7, method 700 includes a step 720 of iteratively listening, by the at least a processor, for a user response to the user event, wherein the user response alerts a subsequent interaction indicator upon a re-evaluation of the user activity data using the behavioral analysis module. In some embodiments, iteratively listening for the user response to the user event may include receiving a subsequent user activity data pertaining to the user and scoring the subsequent user activity data as a function of the user activity data using the behavioral analysis module. This may be implemented, without limitations, as described above with reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for assisted learning, wherein the apparatus comprises:
at least a processor; and
a memory communicatively connected to the at least a processor, wherein the memory contains instructions configuring the at least a processor to:
receive user data pertaining to a user, wherein the user data comprises user activity data comprising handwritten text;
convert the handwritten text into digital format by an optical character recognition (OCR) process, wherein converting the handwritten text into the digital format comprises converting images of the handwritten text in into the digital format and further comprises:
pre-processing image components of the images, wherein pre-processing the image components comprises:
de-skewing at least one of the image components by applying a transform to the at least one of the image components;
using binarization to convert at least a portion of one of the images from color or greyscale to a binary image format; and
using normalization to normalize an aspect ratio of at least one of the image components;
implementing an OCR algorithm comprising a matrix matching process, wherein implementing the OCR algorithm comprises:
comparing pixels of at least one of the pre-processed images to pixels of a stored glyph on a pixel-by-pixel basis; and
ascertaining a similar font and scale therebetween based on the comparison; and
post-processing an output of the matrix matching process to increase OCR accuracy by constraining the output to a lexicon containing a set of words whose occurrence is permitted;
determine an interaction indicator by evaluating the user activity data including the converted handwritten text using a behavioral analysis module, wherein determining an interaction indicator further comprises utilizing one or more web beacons configured to track at least a user interaction with a web page, wherein each web beacon of the one or more web beacons are embedded at a unique section of the web page, wherein determining the interaction indicator further comprises:
generating the behavioral analysis module, wherein the behavioral analysis module comprises an input layer of nodes, at least one intermediate layer, and an output layer of nodes, wherein a connection between nodes is created, wherein the connection between nodes in adjacent layers is adjusted to produce desired values at the output nodes;
scoring, using the behavioral analysis module, the user activity data using a scoring function, wherein the scoring function includes a frequency, duration, and significance of an interaction of a user, wherein an overall scoring of the user activity data as a function of the interaction of the user is weighted as a function of a weighting coefficient, wherein the weighting coefficient is adjusted as a function of a real-time iterative feedback loop to refine the weighting coefficient;
averaging the scoring of the user activity data to derive a composite score, wherein the composite score represents an overall interaction level of the user, wherein the user activity data is classified into one or more user categories based on the composite score;
outputting, using the behavioral analysis module, the interaction indicator as a function of the composite score;
identifying a user archetype based on the user activity data; and
validating the user archetype against a pre-defined set of behavioral archetypes;
selectively initiate a user event based on the validated user archetype; and
iteratively listen for a user response to the user event, wherein the user response alerts a subsequent interaction indicator upon a re-evaluation of the user activity data using the behavioral analysis module.

2. The apparatus of claim 1, wherein the user activity data comprises at least one cue datum.

3. The apparatus of claim 1, wherein receiving the user data comprises receiving the user data using a chatbot.

4. The apparatus of claim 1, wherein identifying the user archetype comprises:
training a user archetype classifier using user archetype training data, wherein the user archetype training data comprises a plurality of user activity data as input correlated to a plurality of user archetypes as output; and
classifying the user activity data into the user archetype using the trained user archetype classifier.

5. The apparatus of claim 1, wherein validating the user archetype comprises:
calculating a similarity metric between the user activity data and each behavioral archetype within the pre-defined set of behavioral archetypes; and
comparing the similarity metric against a pre-determined threshold.

6. The apparatus of claim 1, wherein the user event comprises at least one user prompt.

7. The apparatus of claim 1, wherein selectively initiating the user event comprises:
generating a plurality of user events using an event generation model trained using user event training data, wherein the user event training data comprises a plurality of behavioral archetypes as input correlated to a plurality of user events as output; and
selecting at least one user event from the plurality of user events based on the validated user archetype.

8. The apparatus of claim 1, wherein selectively initiating the user event further comprises:
generating a decision tree as a function of a plurality of user events, wherein the decision tree comprises:
a plurality of nodes comprising at least a root node and at least a terminal node connected to the at least a root node, wherein:
the at least a root node contains a first user event of the plurality of user events; and
the at least a terminal node contains a second user event of the plurality of user events, wherein the first user event is a pre-requisite of the second user event.

9. The apparatus of claim 8, wherein selectively initiating the user event further comprises:
traversing the generated decision tree as a function of the interaction indicator; and
selectively initiating the user event based on the decision tree traversal.

10. The apparatus of claim 1, wherein iteratively listen for the user response to the user event comprises:
receiving a subsequent user activity data pertaining to the user; and
scoring the subsequent user activity data as a function of the user activity data using the behavioral analysis module.

11. A method for assisted learning, wherein the method comprises:
receiving, by at least a processor, user data pertaining to a user, wherein the user data comprises user activity data comprising handwritten text;
converting, by the at least a processor, the handwritten text into digital format by an optical character recognition (OCR) process, wherein converting the handwritten text into the digital format comprises converting images of the handwritten text in into the digital format and further comprises:
pre-processing image components of the images, wherein pre-processing the image components comprises:
de-skewing at least one of the image components by applying a transform to the at least one of the image components;
using binarization to convert at least a portion of one of the images from color or greyscale to a binary image format; and
using normalization to normalize an aspect ratio of at least one of the image components;
implementing an OCR algorithm comprising a matrix matching process, wherein implementing the OCR algorithm comprises:
comparing pixels of at least one of the pre-processed images to pixels of a stored glyph on a pixel-by-pixel basis; and
ascertaining a similar font and scale therebetween based on the comparison; and
post-processing an output of the matrix matching process to increase OCR accuracy by constraining the output to a lexicon containing a set of words whose occurrence is permitted;
determining, by the at least a processor, an interaction indicator by evaluating the user activity data including the converted handwritten text using a behavioral analysis module, wherein determining the interaction indicator comprises utilizing one or more web beacons configured to track at least a user interaction with a web page, wherein each web beacon of the one or more web beacons are embedded at a unique section of the web page, wherein determining the interaction indicator further comprises:
generating the behavioral analysis module, wherein the behavioral analysis module comprises an input layer of nodes, at least one intermediate layer, and an output layer of nodes, wherein a connection between nodes is created, wherein the connection between nodes in adjacent layers is adjusted to produce desired values at the output nodes;
scoring, using the behavioral analysis module, the user activity data using a scoring function, wherein the scoring function includes a frequency, duration, and significance of an interaction of a user, wherein an overall scoring of the user activity data as a function of the interaction of the user is weighted as a function of a weighting coefficient, wherein the weighting coefficient is adjusted as a function of a real-time iterative feedback loop to refine the weighting coefficient;
averaging the scoring of the user activity data to derive a composite score, wherein the composite score represents an overall interaction level of the user, wherein the user activity data is classified into one or more user categories based on the composite score;
outputting, using the behavioral analysis module, the interaction indicator as a function of the composite score;
identifying a user archetype based on the user activity data; and
validating the user archetype against a pre-defined set of behavioral archetypes;
selectively initiating, by the at least a processor, a user event based on the validated user archetype; and
iteratively listening, by the at least a processor, for a user response to the user event, wherein the user response alerts a subsequent interaction indicator upon a re-evaluation of the user activity data using the behavioral analysis module.

12. The method of claim 11, wherein the user activity data comprises at least one cue datum.

13. The method of claim 11, wherein receiving the user data comprises receiving the user data using a chatbot.

14. The method of claim 11, wherein identifying the user archetype comprises:
training a user archetype classifier using user archetype training data, wherein the user archetype training data comprises a plurality of user activity data as input correlated to a plurality of user archetypes as output; and
classifying the user activity data into the user archetype using the trained user archetype classifier.

15. The method of claim 11, wherein validating the user archetype comprises:
calculating a similarity metric between the user activity data and each behavioral archetype within the pre-defined set of behavioral archetypes; and
comparing the similarity metric against a pre-determined threshold.

16. The method of claim 11, wherein the user event comprises at least one user prompt.

17. The method of claim 11, wherein selectively initiating the user event comprises:
generating a plurality of user events using an event generation model trained using user event training data, wherein the user event training data comprises a plurality of behavioral archetypes as input correlated to a plurality of user events as output; and
selecting at least one user event from the plurality of user events based on the validated user archetype.

18. The method of claim 11, wherein selectively initiating the user event further comprises:
generating a decision tree as a function of a plurality of user events, wherein the decision tree comprises:
a plurality of nodes comprising at least a root node and at least a terminal node connected to the at least a root node, wherein:
the at least a root node contains a first user event of the plurality of user events; and
the at least a terminal node contains a second user event of the plurality of user events, wherein the first user event is a pre-requisite of the second user event.

19. The method of claim 18, wherein selectively initiating the user event further comprises:
traversing the generated decision tree as a function of the interaction indicator; and
selectively initiating the user event based on the decision tree traversal.

20. The method of claim 11, wherein iteratively listening for the user response to the user event comprises:
receiving a subsequent user activity data pertaining to the user; and
scoring the subsequent user activity data as a function of the user activity data using the behavioral analysis module.
